(19) United States
(12) Patent Application Publication
(10) Pub. No.: US 2012/0163554 A1
(43) Pub. Date: Jun. 28, 2012

(54) RADIOLOGICAL IMAGE DETECTION APPARATUS, RADIOGRAPHIC APPARATUS AND RADIOGRAPHIC SYSTEM

(75) Inventor: Takuji Tada, Kanagawa (JP)

(73) Assignee: FUJIFILM Corporation, Tokyo (JP)

(21) Appl. No.: 13/306,305

(22) Filed: Nov. 29, 2011

(30) Foreign Application Priority Data
Dec. 22, 2010 (JP) 2010-286767

(51) Int. Cl. G21K 1/10

(52) U.S. Cl. 378/154

(57) ABSTRACT

A radiological image detection apparatus includes a first grating unit, a grating pattern unit, a radiological image detector, and an anti-scatter grating. The grating pattern unit has a period that substantially coincides with a pattern period of a radiological image formed by radiation having passed through the first grating unit. The radiological image detector detects the radiological image masked by the grating pattern unit. The anti-scatter grating is arranged on a path of the radiation incident onto the radiological image detector and removes scattered radiation. A smoothing process is performed for at least one of a surface and a backside of the anti-scatter grating intersecting with a traveling direction of the radiation.

### CROSS-REFERENCE TO RELATED APPLICATIONS

This application claims the benefit of Japanese Patent Application No. 2010-286767 (filed on Dec. 22, 2010), the entire contents of which are hereby incorporated by reference.

### BACKGROUND

1. Technical Field

The invention relates to a radiological image detection apparatus, a radiographic apparatus and a radiographic system capable of enabling a phase contrast imaging of a subject by using radiation such as X-ray.

2. Description of Related Art

Since X-ray attenuates depending on an atomic number of an element configuring a material and a density and a thickness of the material, it is used as a probe for seeing through an inside of a subject. An imaging using the X-ray is widely spread in fields of medical diagnosis, nondestructive inspection and the like.

In a general X-ray imaging system, a subject is arranged between an X-ray source that irradiates the X-ray and an X-ray image detector that detects the X-ray, and a transmission image of the subject is captured. In this case, the X-ray irradiated from the X-ray source toward the X-ray image detector is subject to the attenuation (absorption) depending on differences of the material properties (for example, atomic numbers, densities and thickness) existing on a path to the X-ray image detector and is then incident onto each pixel of the X-ray image detector. As a result, an X-ray absorption image of the subject is detected and captured by the X-ray image detector. As the X-ray image detector, a flat panel detector (FPD) that uses a semiconductor circuit is widely used in addition to a combination of an X-ray intensifying screen and a film and a photostimulable phosphor.

However, the X-ray absorption ability is reduced in case of the material consisting of the element having the smaller atomic number. Accordingly, for the soft biological tissue or soft material, it is not possible to obtain the sufficient contrast of an image for the X-ray absorption contrast image. For example, articular cartilage part and synovidal fluid configuring an articulation of the body are mostly comprised of water. Thus, since a difference of the X-ray absorption amounts thereof is small, it is difficult to obtain the sufficient contrast of the images.

Regarding the above problems, instead of the intensity change of the X-ray by the subject, a research on an X-ray phase contrast imaging of obtaining an image (hereinafter, referred to as a phase contrast image) based on a phase shift of the X-ray wave front caused by the difference in refraction index of the subject has been actively carried out in recent years. In general, it has been known that when the X-ray is incident onto an object, the phase of the X-ray wave front, rather than the intensity of the X-ray, shows the higher interaction. Accordingly, in the X-ray phase contrast imaging of using the phase difference, it is possible to obtain a high contrast image even for a weak absorption material having a low X-ray absorption ability. As the X-ray phase contrast imaging, an X-ray imaging system has been recently suggested which uses an X-ray Talbot interferometer having two transmission diffraction gratings (phase type grating and absorption type grating) and an X-ray image detector (for example, refer to JP-2008-200359-A).

The X-ray Talbot interferometer includes a first diffraction grating (phase type grating or absorption type grating) that is arranged at a rear side of a subject, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase shift) with the subject, which is arranged between the X-ray source and the first diffraction grating, and the X-ray.

In the X-ray Talbot interferometer, a moiré fringe that is generated by superimposition (intensity modulation) of the self-image of the first diffraction grating and the second diffraction grating is detected and a change of the moiré fringe by the subject is analyzed, so that phase information of the subject is acquired. As the analysis method of the moiré fringe, a fringe scanning method has been known, for example. According to the fringe scanning method, a plurality of imaging is performed while the second diffraction grating is translation-moved with respect to the first diffraction grating in a direction, which is substantially parallel with a plane of the first diffraction grating and is substantially perpendicular to a grating extending direction of the first diffraction grating, with a scanning pitch that is obtained by equally partitioning the grating pitch, and an angular distribution (differential phase image) of the X-ray refracted at the subject is acquired from changes of respective pixel values obtained in the X-ray image detector. Based on the angular distribution, it is possible to acquire a phase contrast image of the subject.

As described above, the X-ray phase contrast imaging is to observe the phase shift of the X-ray wave front that is caused when the X-ray passes through the subject. The observation of the phase shift corresponds to an observation of the change of a light path of the X-ray, which is caused when the X-ray passes through the subject, i.e., the refraction of the X-ray. However, in addition to the refraction, there are physical phenomena that change the light path of the X-ray (for example, Compton scattering and Rayleigh scattering). The phenomena deteriorate the signals of the respective pixels, which are generated by the phase shift caused by the X-ray refraction.

Regarding the above scatterings, JP-2008-200359-A suggests that there is a possibility that a second diffraction grating having a plurality of strips formed in a high aspect ratio will also function as an anti-scatter grating.

In the meantime, also in the X-ray absorption contrast imaging, it is helpful to remove the scattered X-ray that deteriorates the image. In JP-A-2003-529087, an anti-scatter grating is provided at a front stage of an intensifying screen and a photosensitive film. Both sides of the anti-scatter grating are adhered with protection covers that are made of a composite material of graphite/epoxy for the purpose of reinforcement of the stack of an X-ray absorption member and an X-ray non-absorption member, prevention of scratch and aesthetic improvement.

When manufacturing the first or second grating, which is used for the X-ray phase contrast imaging, in the high aspect ratio capable of securing the scattering removal function, there are many difficulties such as difficulty in forming strips in a high aspect ratio by an etching and the like, non-uniformity of a substrate thickness, in-plane uniformity due to collapse of the strip or pitch variation, and the like. Regarding this, it is considered to prepare an anti-scatter grating that absorbs the scattered X-ray, separately from the first and second gratings. However, the anti-scatter grating may deteriorate a quality of a phase contrast image. In the phase contrast imaging, the refraction angle of the X-ray is measured as described above. Therefore, when the X-ray is refracted due to a structure or surface state of the anti-scatter grating, it is reflected as shading on the phase contrast image.

As disclosed in JP-A-2003-529087, the anti-scatter grating is formed by slicing a stack, in which a lead foil and a gap material are alternately arranged, with a thickness of about 0.5 mm along a main surface. However, in the phase contrast imaging, even a slight unevenness of the sliced mark on the surface of the anti-scatter grating causes the X-ray refraction, thereby deteriorating the quality of the phase contrast image. Like this, since the X-ray refraction, which is slightly caused by the sliced mark and the like, can be also detected, the image resolution of the phase contrast imaging is considerably higher than that of the X-ray imaging based on the X-ray intensity difference.

In the above phase contrast imaging, when the protection covers are adhered to the main body of the anti-scatter grating, as disclosed in JP-A-2003-529087, the air bubbles, the foreign substances and the like between the main body of the anti-scatter grating and the protection covers may deteriorate the quality of the phase contrast image. In the meantime, JP-A-2003-529087 suggests forming the gap material by a high molecular material including a plurality of air bubbles and the like, thereby reducing an absorption amount of the X-ray in the gap and thus reducing the radiation dose of the X-ray source. However, such air bubbles also may deteriorate the quality of the phase contrast image.

The invention has been made to solve the above problems. An object of the invention is to provide a radiological image detection apparatus, a radiographic apparatus and a radiographic system capable of reducing scattered radiation without influencing a quality of a phase contrast image.

### SUMMARY OF INVENTION

[1] According to an aspect of the invention, a radiological image detection apparatus includes a first grating unit, a grating pattern unit, a radiological image detector, and an anti-scatter grating. The grating pattern unit has a period that substantially coincides with a pattern period of a radiological image formed by radiation having passed through the first grating unit. The radiological image detector detects the radiological image masked by the grating pattern unit. The anti-scatter grating is arranged on a path of the radiation incident onto the radiological image detector and removes scattered radiation. A smoothing process is performed for at least one of a surface and a backside of the anti-scatter grating intersecting with a traveling direction of the radiation.

[2] According to another aspect of the invention, a radiographic apparatus includes the radiological image detection apparatus of [1] and a radiation source that irradiates the radiation toward the first grating unit.

[3] According to another aspect of the invention, a radiographic system includes the radiological image detection apparatus of [2], and a calculation processing unit. The calculation processing unit calculates, from an image detected by the radiological image detector of the radiographic apparatus, a refraction angle distribution of the radiation incident onto the radiological image detector and generates a phase contrast image of a subject based on the refraction angle distribution.

According to the invention, it is possible to reduce the scattered radiation without influencing a quality of a phase contrast image.

### BRIEF DESCRIPTION OF THE DRAWINGS

FIG. 1 is a side view pictorially showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector by using blocks.

FIG. 4 is a perspective view of first and second gratings, an anti-scatter grating and a radiological image detector.

FIG. 5 is a partial side sectional view of the first and second gratings, the anti-scatter grating and the radiological image detector.

FIG. 6 is a pictorial view showing a mechanism for changing a period of an interference fringe (moiré) resulting from interaction of the first and second gratings.

FIG. 7 is a pictorial view for illustrating refraction of radiation by a subject.

FIG. 8 is a pictorial view for illustrating a fringe scanning method.

FIG. 9 is a graph showing pixel signals of the radiological image detector in accordance with the fringe scanning.

FIG. 10 is a pictorial view showing another example of a configuration of a radiographic system for illustrating an illustrative embodiment of the invention.

FIG. 11 is a pictorial view showing a configuration of a modified embodiment of the radiographic system of FIG. 10.

FIG. 12 is a pictorial view showing another example of a configuration of a radiographic system for illustrating an illustrative embodiment of the invention.

FIG. 13 is a pictorial view showing another example of a configuration of a radiographic system for illustrating an illustrative embodiment of the invention.

FIG. 14 shows another example of a configuration of a radiographic system for illustrating an illustrative embodiment of the invention, which shows a configuration of a radiological image detector thereof.

FIG. 15 shows a schematic configuration of another example of a radiographic system for illustrating an illustrative embodiment of the invention.

FIG. 16 shows a schematic configuration of an optical reading type radiological image detector.

FIG. 17 shows an arrangement relation of a first grating, a second grating and pixels of a radiological image detector.

FIG. 18 shows a method of setting an inclination angle of the first grating relative to the second grating.

FIG. 19 shows a method of adjusting an inclination angle of the first grating relative to the second grating.

FIG. 20 illustrates a recording operation of an optical reading type radiological image detector.

FIG. 21 illustrates a reading operation of the optical reading type radiological image detector.

FIG. 22 shows an operation of acquiring a plurality of fringe images, based on image signals read out from the optical reading type radiological image.

FIG. 23 shows an operation of acquiring a plurality of fringe images, based on image signals read out from the optical reading type radiological image detector.

FIG. 24 shows an arrangement relation between a radiological image detector using TFT switches and the first and second gratings.

FIG. 25 shows a schematic configuration of a radiological image detector using CMOSs.

FIG. 26 shows a configuration of one pixel circuit of the radiological image detector using CMOSs.

FIG. 27 shows an arrangement relation between the radiological image detector using CMOSs and the first and second gratings.

FIG. 28 is a schematic view showing another example of a configuration of a radiological phase image capturing apparatus for illustrating an illustrative embodiment of the invention.

FIG. 29 shows a schematic configuration of an illustrative embodiment of the radiological image detector.

FIG. 30 illustrates a recording operation of the radiological image detector according to an illustrative embodiment.

FIG. 31 illustrates a reading operation of the radiological image detector according to an illustrative embodiment.

FIG. 32 shows another illustrative embodiment of the radiological image detector.

FIG. 33 illustrates a recording operation of the radiological image detector according to another illustrative embodiment.

FIG. 34 illustrates a reading operation of the radiological image detector according to another illustrative embodiment.

FIG. 35 shows an example of a grating having a grating surface that is a curved concave surface.

FIG. 36 shows another example of a radiographic system for illustrating an illustrative embodiment of the invention, which is a block diagram showing a configuration of a calculation processing unit.

FIG. 37 is a graph showing pixel signals of a radiological image detector for illustrating a process in the calculation processing unit of the radiographic system shown in FIG. 36.

FIG. 38 is a pictorial view for illustrating the X-ray refraction by the anti-scatter grating (a surface of the anti-scatter grating is not smoothed).

FIG. 39 is a pictorial view for illustrating the X-ray refraction by the anti-scatter grating (a film is formed).

### DETAILED DESCRIPTION

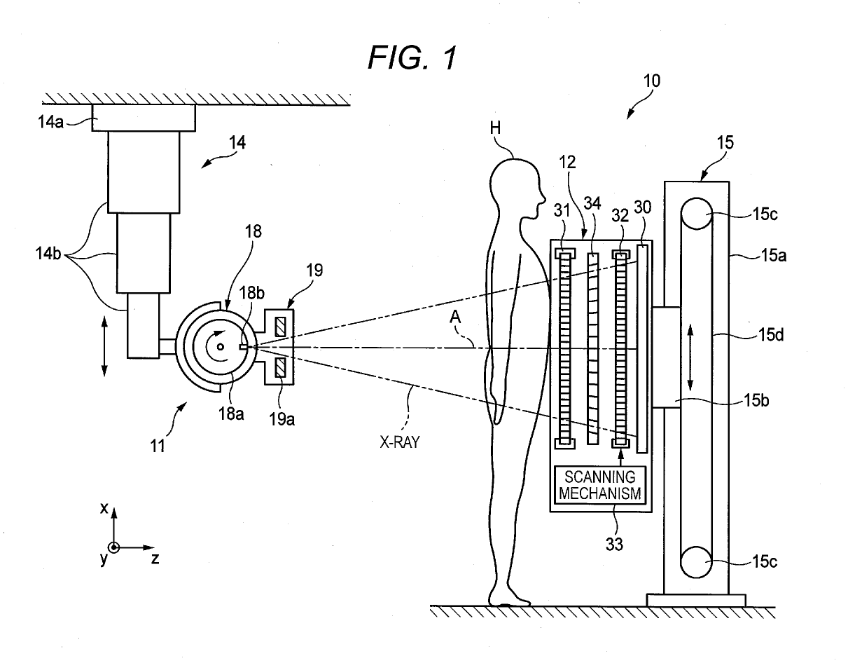

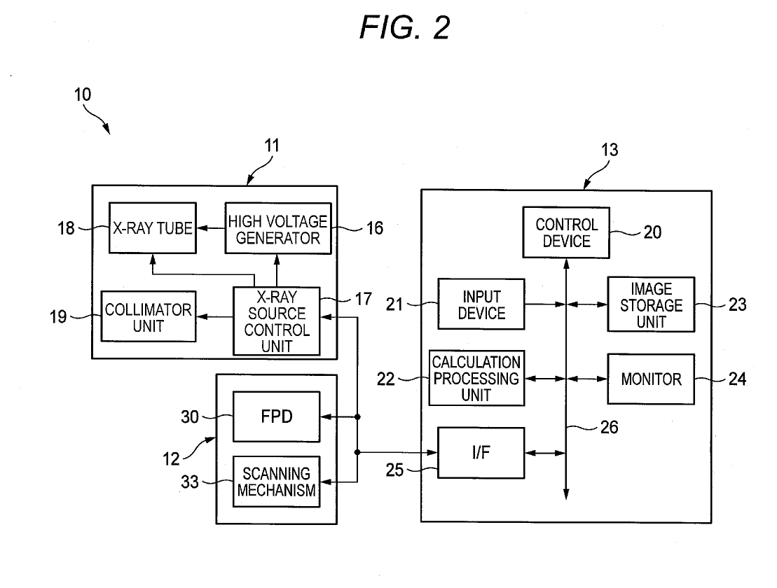

FIG. 1 shows an example of a configuration of a radiographic system for illustrating an illustrative embodiment of the invention and FIG. 2 shows a control block diagram of the radiographic system of FIG. 1.

In the meantime, the same configurations as those already described are indicated with the same reference numerals and the descriptions thereof are omitted. The differences from the configurations already described will be described.

An X-ray imaging system 10 is an X-ray diagnosis apparatus that performs an imaging while a subject (patient) H stands, and includes an X-ray source 11 that radiates the subject H, an imaging unit 12 functioning as a radiological image detection apparatus that is opposed to the X-ray source 11 with the subject H being interposed between the X-ray source 11 and the imaging unit, detects the X-ray having penetrated the subject H from the X-ray source 11 and thus generates image data and a console 13 (refer to FIG. 2) that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17, and a collimator unit 19 having a moveable collimator 19a that limits an irradiation field so as to shield a part of the X-ray generated from the X-ray tube 18, which part does not contribute to an inspection area of the subject H. The X-ray tube 18 is a rotary anode type that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b.

The X-ray source holding apparatus 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 15c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that serves as a radiological image detector having a semiconductor circuit, a first absorption type grating 31 and a second absorption type grating 32 that detect a phase shift of the X-ray wave front caused by the difference in the refraction index of the subject H and perform a phase contrast imaging, and an anti-scatter grating 34 that removes or reduces scattered X-ray.

The imaging unit 12 is provided with a scanning mechanism 33 that translation-moves the second absorption type grating 32 in the upper-lower direction (x direction) and thus relatively moves the first absorption type grating 31 and the second absorption type grating 32.

The FPD 30 has a detection surface that is arranged to be orthogonal to the optical axis A of the X-ray irradiated from the X-ray source 11. As specifically described in the below, the first and second absorption type gratings 31, 32 and the anti-scatter grating 34 are arranged on a path of the X-ray between the X-ray source 11 and the FPD 30.

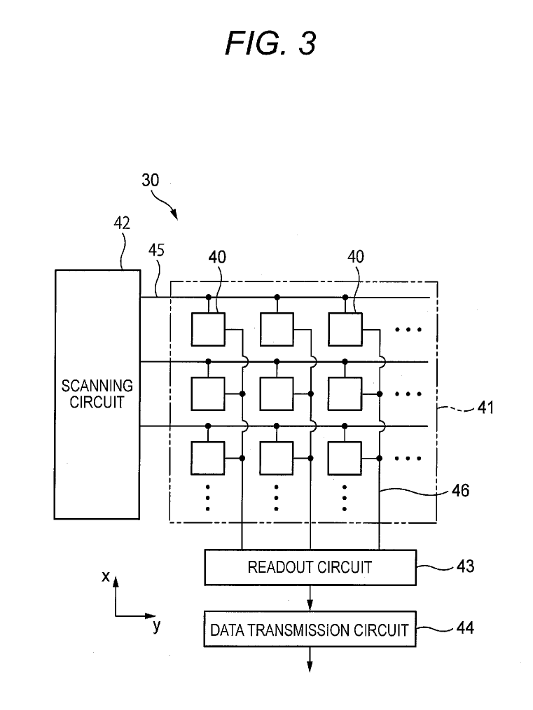

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of Terbium-activated Gadolinium oxysulfide (Gd₂O₂S:Tb), Cesium iodide doped with Thallium (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

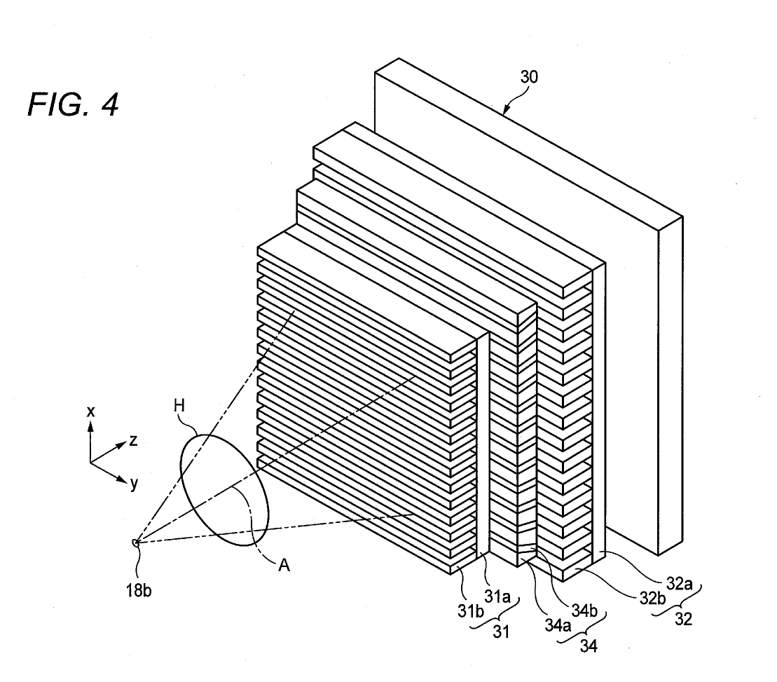

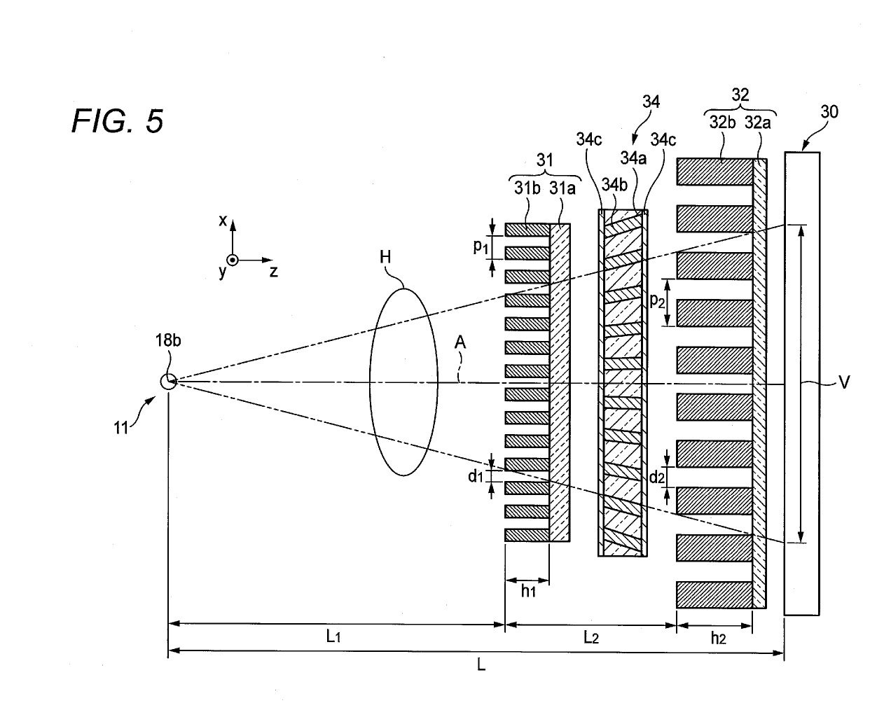

FIGS. 4 and 5 show the first grating 31, the anti-scatter grating 34, the second grating 32 and the FPD 30.

The first absorption type grating 31 has a substrate 31a and a plurality of X-ray shield units 31b that is a plurality of strips arranged on the substrate 31a. The second absorption type grating 32 that is a grating pattern also has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (one of x and y direction, and the y direction in the example of FIG. 4) orthogonal to the optical axis A of the X-ray irradiated from the X-ray source 11. As the materials of the respective X-ray shield units 31b, 32b, materials having high X-ray attenuation coefficient are preferable. For example, the heavy metal such as gold, platinum and the like is preferable. The X-ray shield units 31b, 32b can be formed by the metal plating, vapor deposition or photolithography method.

The X-ray shield units 31b are arranged on the in-plane orthogonal to the optical axis A of the X-ray with a constant pitch p₁ and at a predetermined interval d₁ in the direction (x direction as a first direction, in the example of FIG. 4) orthogonal to the one direction. Likewise, the X-ray shield units 32b are also arranged on the in-plane orthogonal to the optical axis A of the X-ray with a constant pitch p₂ and at a predetermined interval d₂ in the x direction.

Since the first and second absorption type gratings 31, 32 provide the incident X-ray with an intensity difference, rather than a phase difference, they are also referred to as amplitude type gratings. In the meantime, the slit (area of the interval d₁ or d₂) may not be a void. For example, the void may be filled with X-ray low absorption material such as polymer material or light metal.

The first and second absorption type gratings 31, 32 are adapted to geometrically project the X-ray having passed through the slits, regardless of the Talbot interference effect. Specifically, the intervals d₁, d₂ are set to be sufficiently larger than an effective wavelength of the X-ray irradiated from the X-ray source 11, so that most of the X-ray included in the irradiated X-ray is enabled to pass through the slits, without being diffracted in the slits. For example, when the rotary anode 18a is made of tungsten and the tube voltage is 50 kV, the effective wavelength of the X-ray is about 0.4 Å. In this case, when the intervals d₁, d₂ are set to be about 1 to 10 μm, most of the X-ray is geometrically projected in the slits without being diffracted.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p₂ and the interval d₂ of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L₁ and a distance from the first absorption type grating 31 to the second absorption type grating 32 is L₂, the grating pitch p₂ and the interval d₂ are determined to satisfy following equations (1) and (2). Meanwhile, d₁ and d₂ may be determined independently.

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L₂ from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L₂ irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p₁ of the first absorption type grating 31, the grating pitch p₂ of the second absorption type grating 32, the X-ray wavelength (typically, effective wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a cone beam and is known by Timm Weitkamp, et al. (Proc. of SPIE, Vol. 6318, 2006, page 63180S).

In the X-ray imaging system 10, the distance L₂ is set to be shorter than the minimum Talbot interference distance Z when m=1 so as to make the imaging unit 12 smaller. That is, the distance L₂ is set by a value within a range satisfying a following equation (4).

$$\begin{matrix}[ equation 4 ] & \\ {L}_{2} < \frac{{p}_{1} {p}_{2}}{ λ} & ( 4 )\end{matrix}$$

In addition, when the X-ray irradiated from the X-ray source 11 can be considered as a substantially parallel beam, the Talbot interference distance Z is expressed by a following equation (5) and the distance L₂ is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having high X-ray attenuation coefficient are used, no small part of X-rays penetrate the X-ray shield units without being absorbed. Accordingly, in order to improve the shield ability of X-ray, it is preferable to make thickness h₁, h₂ of the X-ray shield units 31b, 32b thicker as much as possible, respectively. For example, when the tube voltage applied to the X-ray tube 18 is 50 kV, it is preferable to shield 90% or more of the irradiated X-ray. In this case, the thickness h₁, h₂ are preferably 100 μm or larger, based on gold (Au).

In the meantime, when the thickness h₁, h₂ of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h₁, h₂ are defined. In order to secure a length V of the effective field of view in the x direction on the detection surface of the FPD 30, when a distance from the X-ray focus 18b to the detection surface of the FPD 30 is L, the thickness h₁, h₂ are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d₁=2.5 μm, d₂=3.0 μm and L=2 m, assuming a typical clinical use in a typical hospital, the thickness h₁ should be 100 μm or smaller and the thickness h₂ should be 120 μm or smaller so as to secure a length of 10 cm as the length V of the effective field of view in the x direction.

The anti-scatter grating 34 is arranged between the first grating 31 and the second grating 32 and has a plurality of X-ray shield units 34b that absorbs and thus removes the scattered X-ray (hereinafter, referred to as scattered ray). The X-ray shield units 34b extend in the y direction and are arranged at an interval in the x direction on the in-plane orthogonal to the optical axis A of the X-ray. X-ray penetration units 34a that allows the X-ray to penetrate therethrough are provided to fill between the X-ray shield units 34b, 34b adjacent to each other.

The anti-scatter grating 34 is manufactured by slicing a base material, in which a plate-shaped X-ray absorption member such as metal foil made of heavy metal such as lead, copper, tungsten and the like and a plate-shaped X-ray penetration member having a lower X-ray attenuation coefficient than the X-ray absorption member, such as substrate made of glass, polymer material, light metal and the like, are alternately stacked, along a plane orthogonal to the stacking direction. The substrate part of the anti-scatter grating manufactured as described above corresponds to the X-ray penetration part 34a and the metal foil part corresponds to the X-ray shield unit 34b. According to this manufacturing method, since a height of the X-ray shield unit 34b is changed by adjusting the slicing thickness, it is possible to easily manufacture an anti-scatter grating having a desired X-ray absorption ability.

The X-ray shield units 34b are formed so that extension lines of upright standing directions thereof on a yz section focus in the X-ray source 11, and the anti-scatter grating becomes a so-called focused grid. As the anti-scatter grating 34 is used, the so-called vignetting that the X-ray is incident onto the X-ray shield units of the anti-scatter grating does not occur well. In the meantime, the angle change of the X-ray refracted at the subject H is typically several μrad, so that the X-ray refracted at the subject H travels along the substantial irradiation direction from the X-ray source 11.

Regarding the method of manufacturing the anti-scatter grating, the anti-scatter grating may be formed by cutting and separating the plate-shaped member sliced from the base material along the stacking direction or a direction intersecting with the stacking direction. Alternatively, the anti-scatter grating may be formed by dicing the base material and then slicing the individual dices.

Here, a surface and a backside of the anti-scatter grating 34 intersecting with the traveling direction of the X-ray are smoothed. Specifically, the surface and backside of the anti-scatter grating 34 intersecting with the optical axis A of the X-ray are respectively formed with thin films 34c (refer to FIG. 5) by a film formation process of using a material such as glass, polymer, light metal and the like. As the material of the thin film 34c, a material that having a lower X-ray attenuation coefficient as much as possible and has a small refractive index difference with the X-ray penetration unit 34a is preferable, such as glass, polymer and light metal. A difference of refractive indices of the X-ray penetration unit 34a and the thin film 34c is preferably smaller than a difference of the refractive indices of water and air. Thereby, it is possible to reduce an influence of the refraction caused between the thin film 34c and the X-ray penetration unit 34a on a signal indicating the refraction that is caused between the subject (human body) H in which most of the components are water and the atmosphere. Herein, the refractive index of the thin film 34c is the substantially same as that of the X-ray penetration unit 34a. In the meantime, the refractive indices are compared in an energy band of about 10 to 150 keV and an energy band radiated from the X-ray source that is used.

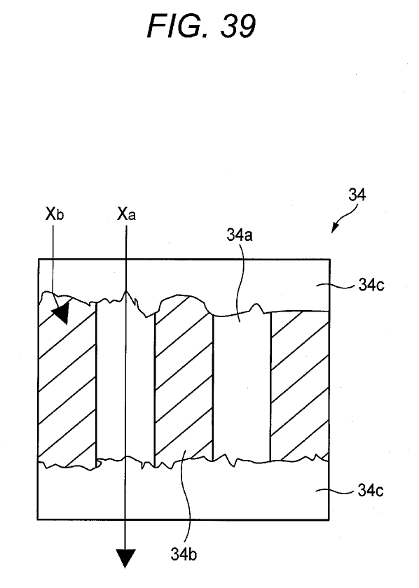

Here, FIGS. 38 and 39 pictorially illustrate the refraction of the X-ray by the anti-scatter grating 34. When the surface smoothing processing is not performed as shown in FIG. 38, the X-ray incident onto the X-ray penetration unit 34a is bent due to the influence of the refraction by the surface roughness of the X-ray penetration unit 34a (Xa in FIG. 38). In the meantime, since the X-ray incident onto the X-ray shield unit 34b is rapidly absorbed even though it is refracted, it is little influenced by the refraction (Xb in FIG. 38).

On the other hand, when the surface smoothing processing is performed by forming the thin film 34c, as shown in FIG. 39, the X-ray incident onto the thin film 34c travels straight while it is little influenced by the refraction due to the unevenness at an interface between the thin film and the X-ray penetration unit because the refractive indices of the thin film 34c and the X-ray penetration unit 34a are the substantially same (Xa in FIG. 39). In the meantime, the X-ray incident onto the X-ray shield unit 34b is refracted at the interface due to the difference of the refractive indices between the X-ray penetration unit 34a and the thin film 34c. However, since the X-ray is rapidly absorbed, it is little influenced by the refraction (Xb in FIG. 39). That is, when the thin film 34c is formed by a material having the substantially same refractive index as that the X-ray penetration unit 34a, the refraction caused between the thin film 34c and the X-ray penetration unit 34a does not have an effect on the signal indicating the refraction caused by the subject H. Therefore, it is possible to prevent a quality of a phase contrast image of the subject H from being deteriorated.

A thickness of the thin film 34c (a thickness from a substrate surface of the anti-scatter grating 34 to the uppermost surface of the thin film 34c) is 100 nm to 1 mm. In order not to lower the transmittance of the anti-scatter grating 34, the thickness of the thin film 34c is preferably thin if at all possible. When the film thickness is 100 nm or thicker, it is possible to smooth the sliced surface of the anti-scatter grating 34, and when the film thickness is 1 mm or thinner, it is possible to use the relatively thickly formed thin film 34c as a holding part of the substrate of the anti-scatter grating 34 without lowering the transmittance of the anti-scatter grating 34 so much.

As described above, since the anti-scatter grating 34 is formed by slicing the base material, the minute unevenness that is the sliced mark is formed on the surface and backside of the anti-scatter grating 34 before the formation of the thin film 34c. However, the thin films 34c are formed, so that the surface and backside of the anti-scatter grating 34 are smoothed. The surface roughness RMS (root-mean-square) of the thin film 34c is set to be 10 nm or smaller. The temperature, the pressure and the like are controlled in the film formation process so that the surface roughness, the film thickness and the like of the thin film 34c become appropriate.

In the meantime, the film formation process may include a sputtering process, a vapor deposition process, a CVD process, an ion plating process, a coating process, a printing process, an adhesion/pressurization process of a film and the like.

In the meantime, the smoothing process of the anti-scatter grating 34 is not limited to the above. That is, at least one of the surface and backside of the anti-scatter grating 34 intersecting with the optical axis A may be smoothed by a grind process. Also in this case, it is preferable that the smoothed surface of the anti-scatter grating has the RMS of 10 nm or smaller.

The components of the scattered ray traveling in the arrangement direction (x direction) of the X-ray shield units 34b are incident and absorbed in the X-ray shield units 34b, so that the anti-scatter grating 34 removes or reduces the scattered ray. Although the scattering of the X-ray may be caused due to particles in the atmosphere, rays except for the X-ray, wavelengths of electromagnetic rays and the like, the strong scattering of the X-ray easily occurs when the X-ray passes through the subject H having a thickness. The anti-scatter grating 34 removes or reduces the scattered X-ray.

Also, since the anti-scatter grating 34 is arranged between the first grating 31 and the second grating 32, the anti-scatter grating 34 also removes or reduces the scattered ray occurring in the first grating 31.

In the imaging unit 12 configured as described above, the intensity-modulated image is formed by the superimposition of the G1 image of the first grating 31 and the second grating 32 and is then captured by the FPD 30. Here, the scattered ray caused by the subject H, the first grating 31 and the like is removed or reduced by the anti-scatter grating 34, so that it is possible to prevent the quality of the phase contrast image from being deteriorated.

A pattern period p₁′ of the G1 image at the position of the second absorption type grating 32 and a substantial grating pitch p₂′ (substantial pitch after the manufacturing) of the second absorption type grating 32 are slightly different depending on the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p₁′ of the G1 image and the grating pitch p₂′, the image contrast becomes a moiré fringe. A period T of the moiré fringe at the detection surface of the FPD is expressed by a following equation (9).

$$\begin{matrix}[ equation 9 ] & \\ T = \frac{L}{{L}_{1} + z} \frac{{p}_{1}^{′} \times {p}_{2}^{′}}{\vert {p}_{1}^{′} - {p}_{2}^{′} \vert} & ( 9 )\end{matrix}$$

When it is intended to detect the moiré fringe with the FPD 30, an arrangement pitch P_{D} of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P_{D} is not an integer multiple of the moiré period T. Even for a case of n≧2, it is possible to detect the moiré fringe in principle. The equation (11) means that the arrangement pitch P_{D} is set to be smaller than the moiré period T.

Since the arrangement pitch P_{D} of the pixels 40 of the FPD 30 are design-determined (in general, about 100 μm) and it is difficult to change the same, when it is intended to adjust the relation of the arrangement pitch P_{D} and the moiré period T, it is preferable to adjust the positions of the first and second absorption type gratings 31, 32 and to change at least one of the pattern period p₁′ of the G1 image and the grating pitch p₂′, thereby changing the moiré period T.

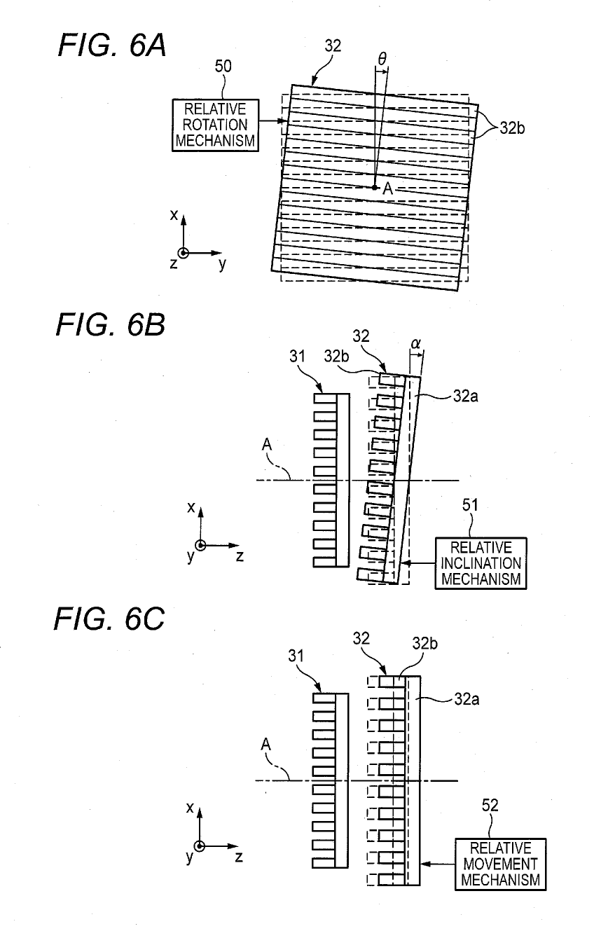

FIGS. 6A, 6B and 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p₂′” to “p₂′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p₂′” to “p₂″×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L₂ between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p₁′” to “p₁′×(L₁+L₂+δ)/(L₁+L₂)”, so that the moiré period T is changed (refer to FIG. 6C).

In the X-ray imaging system 10, since the imaging unit 12 is not the Talbot interferometer and can freely set the distance L₂, it can appropriately adopt the mechanism for changing the distance L₂ to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the subject H is arranged between the X-ray source 11 and the first absorption type grating 31, the moiré fringe that is detected by the FPD 30 is modulated by the subject H. An amount of the modulation is proportional to the angle of the X-ray that is deviated by the refraction effect of the subject H. Accordingly, it is possible to generate the phase contrast image of the subject H by analyzing the moiré fringe detected by the FPD 30.

In the below, an analysis method of the moiré fringe is described.

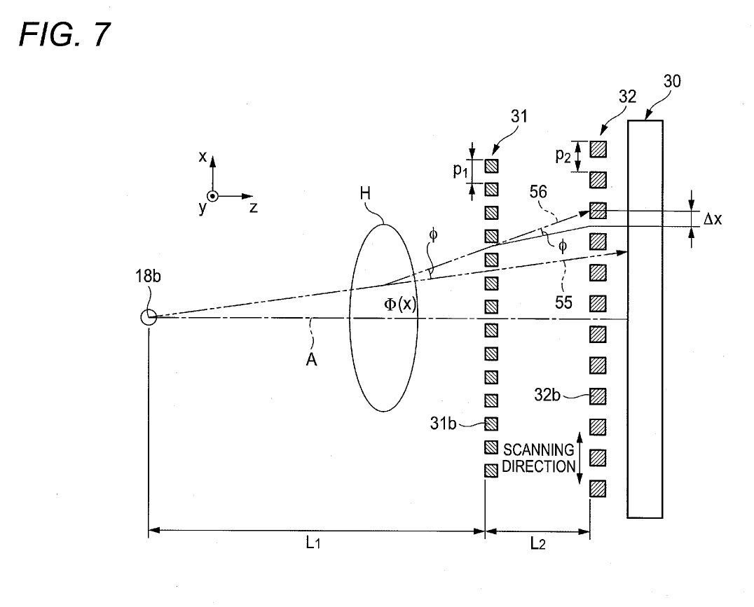

FIG. 7 shows one X-ray that is refracted in correspondence to a phase shift distribution Φ(x) in the x direction of the subject H. In the meantime, an anti-scatter grid is not shown in FIG. 7.

A reference numeral 55 indicates a path of the X-ray that goes straight when there is no subject H. The X-ray traveling along the path 55 passes through the first and second absorption type gratings 31, 32 and is then incident onto the FPD 30. A reference numeral 56 indicates a path of the X-ray that is refracted and deviated by the subject H. The X-ray traveling along the path 56 passes through the first absorption type grating 31 and is then shielded by the second absorption type grating 32.

The phase shift distribution Φ(x) of the subject H is expressed by a following equation (12), when a refractive index distribution of the subject H is indicated by n(x, z) and the traveling direction of the X-ray is indicated by Z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) using a wavelength λ, of the X-ray and the phase shift distribution Φ(x) of the subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the subject H is related to the phase shift distribution Φ(x) of the subject H. Also, the amount of displacement Δx is related to a phase difference amount ψ of a signal output from each pixel 40 of the FPD 40 (a phase difference amount of a signal of each pixel 40 obtained when there is the subject H and when there is no subject H), as expressed by a following equation (15).

$$\begin{matrix}[ equation 15 ] & \\ ψ = \frac{2 π}{{p}_{2}} Δ x = \frac{2 π}{{p}_{2}} {L}_{2} ϕ & ( 15 )\end{matrix}$$

Therefore, when the phase difference amount ψ of a signal of each pixel 40 is calculated, the refraction angle φ is obtained from the equation (15) and a differential of the phase shift distribution Φ(x) is obtained by using the equation (14). Hence, by integrating the differential of the phase shift distribution Φ(x) with respect to x, it is possible to generate the phase shift distribution Φ(x) of the subject H, i.e., the phase contrast image of the subject H. In the X-ray imaging system 10 of this illustrative embodiment, the phase difference amount ψ is calculated by using a fringe scanning method that is described below.

In the fringe scanning method, an imaging is performed while one of the first and second absorption type gratings 31, 32 is stepwise translation-moved relatively to the other in the x direction, in other words, an imaging is performed while changing the phases between both gratings. In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance in the x direction reaches one period of the grating period of the second absorption type grating 32, the phase change between the two gratings reaches 2π, and the moiré fringe returns to its original position. Regarding the movement of the moiré fringe, while moving the second absorption type grating 32 by 1/n (n: integer) with respect to the grating pitch p₂, the fringe images are captured by the FPD 30 and the signals of the respective pixels 40 are obtained from the captured fringe images and calculated in the calculation processing unit 22, so that the phase difference amount ψ of the signal of each pixel 40 is obtained.

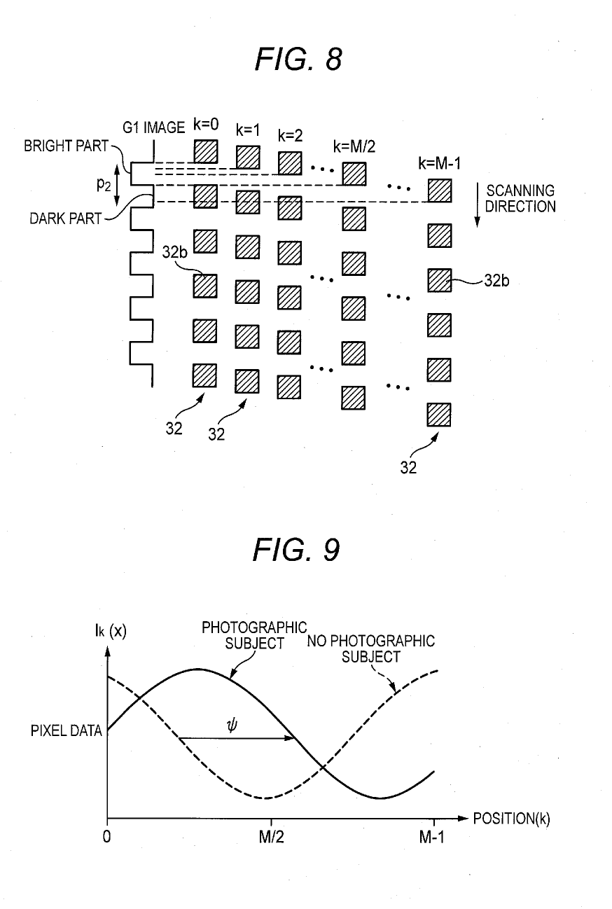

FIG. 8 pictorially shows that the second absorption type grating 32 is moved with a scanning pitch (p₂/M) (M: integer of 2 or larger) that is obtained by dividing the grating pitch p₂ into M.

The scanning mechanism 33 sequentially translation-moves the second absorption type grating 32 to each of M scanning positions of k=0, 1, 2, . . . , M−1. In FIG. 8, an initial position of the second absorption type grating 32 is a position (k=0) at which a dark part of the G1 image at the position of the second absorption type grating 32 when there is no subject H substantially coincides with the X-ray shield unit 32b. However, the initial position may be any position of k=0, 1, 2, . . . , M−1.

First, at the position of k=0, mainly, the X-ray that is not refracted by the subject H passes through the second absorption type grating 32. Then, when the second absorption type grating 32 is moved in order of k=1, 2, . . . , regarding the X-ray passing through the second absorption type grating 32, the component of the X-ray that is not refracted by the subject H is decreased and the component of the X-ray that is refracted by the subject H is increased. In particular, at the position of k=M/2, mainly, only the X-ray that is refracted by the subject H passes through the second absorption type grating 32. At the position exceeding k=M/2, contrary to the above, regarding the X-ray passing through the second absorption type grating 32, the component of the X-ray that is refracted by the subject H is decreased and the component of the X-ray that is not refracted by the subject H is increased.

At each position of k=0, 1, 2, . . . , M−1, when the imaging is performed by the FPD 30, M signal values are obtained for the respective pixels 40. In the below, a method of calculating the phase difference amount ψ of the signal of each pixel 40 from the M signal values is described. When a signal value of each pixel 40 at the position k of the second absorption type grating 32 is indicated with Ik(x), Ik(x) is expressed by a following equation (16).

$$\begin{matrix}[ equation 16 ] & \\ {I}_{k} ( x ) = {A}_{0} + {\sum }_{n > 0} {A}_{n} exp [ 2 π i \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A0 is the intensity of the incident X-ray and An is a value corresponding to the contrast of the signal value of the pixel 40 (n is a positive integer). Also, φ(x) indicates the refraction angle φ as a function of the coordinate x of the pixel 40.

Then, when a following equation (17) is used, the refraction angle φ(x) is expressed by a following equation (18).

$$\begin{matrix}[ equation 17 ] & \\ {\sum }_{k = 0}^{M - 1} exp ( - 2 π i \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg[ ] is a symbol of an operation which means the calculation of an argument. The calculated argument corresponds to the phase difference amount ψ of the signal of each pixel 40. Therefore, from the M signal values obtained from the respective pixels 40, the phase difference amount ψ of the signal of each pixel 40 is calculated based on the equation (18), so that the refraction angle φ (x) is acquired.

FIG. 9 shows a signal of one pixel of the radiological image detector, which is changed with the fringe scanning.

The M signal values obtained from the respective pixels 40 are periodically changed with the period of the grating pitch p₂ with respect to the position k of the second absorption type grating 32. The broken line of FIG. 9 indicates the change of the signal value when there is no subject H and the solid line of FIG. 9 indicates the change of the signal value when there is the subject H. A phase difference of both waveforms corresponds to the phase difference amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis.

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the subject H is finally displayed on the monitor 24.

In the X-ray phase contrast imaging, the surface and backside of the anti-scatter grating 34 are smoothed as described above, so that it is possible to prevent the X-ray from being refracted at the slight unevenness on the surface and backside of the anti-scatter grating 34 and the quality of the phase contrast image from being lowered due to the shading at the unevenness. The refraction of the X-ray is noticeably generated at an interface of respective areas of an object in which the optical distances of the X-ray penetrating the object are different, particularly, at an edge of the object. By apprehending the refraction of the X-ray, the X-ray phase contrast imaging has the high resolution. However, due to the high resolution, the minute unevenness such as sliced mark may be reflected on a diagnosis image. Since the anti-scatter grating 34 is formed by slicing the base material, the sliced mark is inevitably generated thereto. However, by performing the smoothing process for the anti-scatter grating 34, it is possible to securely prevent the sliced mark from being reflected on the diagnosis image.

Like this, it is possible to reduce the scattered radiation without deteriorating the quality of the phase contrast image.

Also, since the refractive indices of the thin film 34c and the X-ray penetration unit 34a are the substantially same, the reflection is not caused well even though the thin film 34c is formed, so that it is possible to suppress the intensity of the X-ray penetrating the X-ray penetration unit 34a from being lowered. Also in this regard, it is possible to prevent the quality deterioration of the phase contrast image.

In addition, since the arrangement direction of the X-ray shield units 34b of the anti-scatter grating 34 and the arrangement direction of the X-ray shield units 32b of the second grating 32 are parallel (all of them face in the x direction), it is possible to absorb and remove the component of the scattered light in the x direction, which highly influences the phase shift distribution Φ(x) having reflected the refraction of the x direction, by the X-ray shield units 34b, which can contributed to the improvement on the quality of the phase contrast image. In the meantime, the arrangement direction of the X-ray shield units of the anti-scatter grating and the arrangement direction of the X-ray shield units of the second grating may intersect with each other. When the arrangement direction of the X-ray shield units of the anti-scatter grating and the arrangement direction of the X-ray shield units of the second grating intersect with each other at an angle of 0 degree or larger and smaller than 90 degrees, it is possible to absorb and remove the x direction component of the scattered X-ray by the X-ray shield units of the anti-scatter grating.

In the meantime, when the angle between the arrangement direction of the X-ray shield units of the anti-scatter grating and the arrangement direction of the X-ray shield units of the second grating is 0 degree or larger and smaller than 90 degrees, a moiré having a periodicity in the x direction may be generated depending on the arrangement pitch of the X-ray shield units of the anti-scatter grating, due to a relation with the arrangement pitch P of the pixels 40 in the x direction with respect to the spatial frequency response. In this case, since the G1 image is also the moiré fringe having a periodicity in the x direction, it is necessary to remove the moiré caused due to the anti-scatter grating 34 and the FPD 30 from an image by appropriate image processing using a frequency filter, and the like. Therefore, the arrangement pitch of the X-ray shield units 34a of the anti-scatter grating 34 may be set as a pitch that does not cause a moiré having a problematic frequency in an image due to a relation with the arrangement pitch P of the pixels 40 in the x direction with respect to the spatial frequency response, so that the above-described image processing is not necessary.

In the meantime, the arrangement direction of the X-ray shield units of the anti-scatter grating and the arrangement direction of the X-ray shield units of the second grating may cross at right angles. According to this configuration, it is possible to prevent the moiré component intersecting in the x direction from being generated by the anti-scatter grating 34. That is, regarding the second grating, since the second grating and the anti-scatter grating do not have a periodicity in the same direction, a moiré is not generated between the second grating and the anti-scatter grating. Regarding the FPD, even when a moiré is generated depending on a period difference between the pixels of the FPD and the anti-scatter grating, since the arrangement direction of the strips of the anti-scatter grating faces in the y direction, the moiré is not moved even though the second grating is scanned in the x direction. Also, since only the intensity change by the image of the first grating (G1 image) and the second grating is reflected on the intensity modulation signals of the respective pixels 40 obtained by scanning the second grating, even when the corresponding moiré is superimposed on the moiré of the x direction by the G1 image and the second grating 32, it does not influence the quality of the phase contrast image. In the fringe scanning method, if the arrangement direction of the strips of the anti-scatter grating does not face in the y direction and a moiré is generated by the anti-scatter grating and the second grating, the moiré is moved in scanning the second grating, so that it is difficult to acquire data. However, when the arrangement direction of the strips of the anti-scatter grating faces in the y direction, since a moiré is not generated by the anti-scatter grating and the second grating, the problem that it is difficult to acquire data is not caused.

It is preferable that the thin film 34c is formed on both the surface and backside of the anti-scatter grating 34, as shown in FIG. 5. However, the thin film 34 may be formed on one of the surface and backside thereof. Regarding the corresponding surface, it is possible to prevent the reflection on the diagnosis image. In the meantime, the thin film 34c may be formed on the entire outer periphery surfaces of the anti-scatter grating, i.e., the surface, the backside and the side surfaces. Alternatively, the thin film may be formed on an X-ray penetration area in the plane of the anti-scatter grating intersecting with the optical axis A.

Also, the anti-scatter grating 34 is formed by slicing the base material. However, the anti-scatter grating is not limited to the configuration. For example, the anti-scatter grating may be configured by forming strips on one or both surfaces of a substrate with a photo etching and the like.

The anti-scatter grating 34 may be arranged between the subject H and the first grating 31 on the path of the X-ray incident onto the FPD 30, in addition to the configuration in which the anti-scatter grating is arranged between the first grating 31 and the second grating 32. Also, two or more scattering removal gratings may be provided on the path of the X-ray incident onto the FPD 30.

Also, the anti-scatter grating is not limited to the anti-scatter grating 34 forming the focused grid. For example, an anti-scatter grating having a so-called parallel grid structure in which a plurality of X-ray shield units is provided in parallel with the optical axis A on the yz section may be used.

In the X-ray imaging system 10, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L₂ from the first absorption type grating 31 to the second absorption type grating 32 and to set the distance L₂ to be smaller than the minimum Talbot interference distance of the Talbot interferometer, it is possible to miniaturize the imaging unit 12.

Also, in the X-ray imaging system 10, the refraction angle φ is calculated by performing the fringe scanning for the projection image of the first grating. Thus, it has been described that both the first and second gratings are the absorption type gratings. However, the invention is not limited thereto. As described above, the invention is also useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe, such as method of using Fourier transform/inverse Fourier transform known in “J. Opt. Soc. Am. Vol. 72, No. 1 (1982) p. 156”, may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the subject. Accordingly, the image based on the refraction angle φ and the image based on the differential of the phase shift distribution Φ are also included in the phase contrast image.

In addition, it may be possible to prepare a phase differential image (differential amount of the phase shift distribution Φ) from an image group that is acquired by performing the imaging (pre-imaging) at a state in which there is no subject. The phase differential image reflects the phase non-uniformity of a detection system (that is, the phase differential image includes a phase difference by the moiré, a grid non-uniformity, a refraction of a radiation dose detector, and the like). Also, by preparing a phase differential image from an image group that is acquired by performing the imaging (main imaging) at a state in which there is a subject and subtracting the phase differential image acquired in the pre-imaging from the phase differential image acquired in the main imaging, it is possible to acquire a phase differential image in which the phase non-uniformity of a measuring system is corrected.

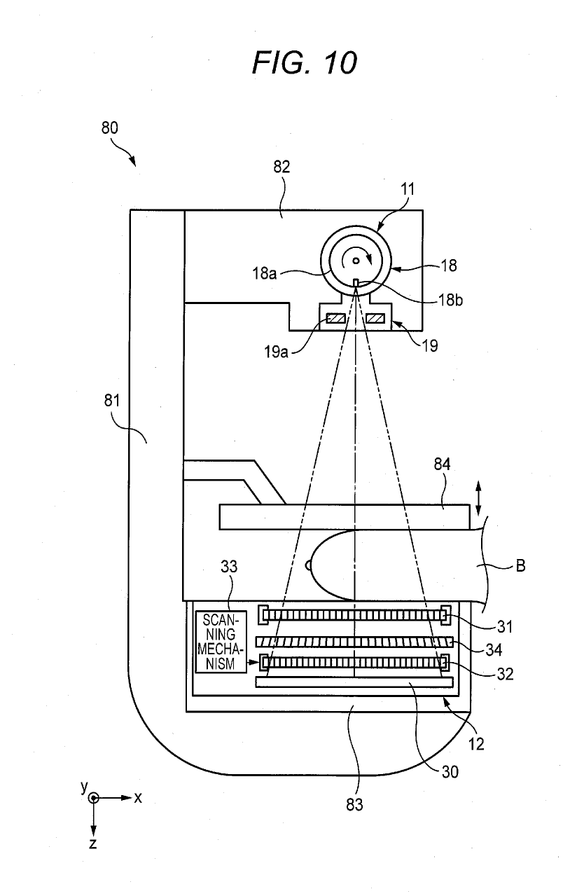

FIG. 10 shows another example of the radiographic system for illustrating an illustrative embodiment of the invention.

A mammography apparatus 80 shown in FIG. 10 is an apparatus of capturing an X-ray image (phase contrast image) of a breast B that is the subject. The mammography apparatus 80 includes an X-ray source accommodation unit 82 that is mounted to one end of an arm member 81 rotatably connected to a base platform (not shown), an imaging platform 83 that is mounted to the other end of the arm member 81 and a compression plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The compression plate 84 is moved by a moving mechanism (not shown) and presses the breast B between the compression plate and the imaging platform 83. At this pressing state, the X-ray imaging is performed.

Also, the collimator unit 19 is provided with the shutter unit 27, as described above, and the configurations of the X-ray source 11 and the imaging unit 12 are the same as those of the X-ray imaging system 10. Therefore, the respective constitutional elements are indicated with the same reference numerals as the X-ray imaging system 10. Since the other configurations and the operations are the same as the above, the descriptions thereof are also omitted.

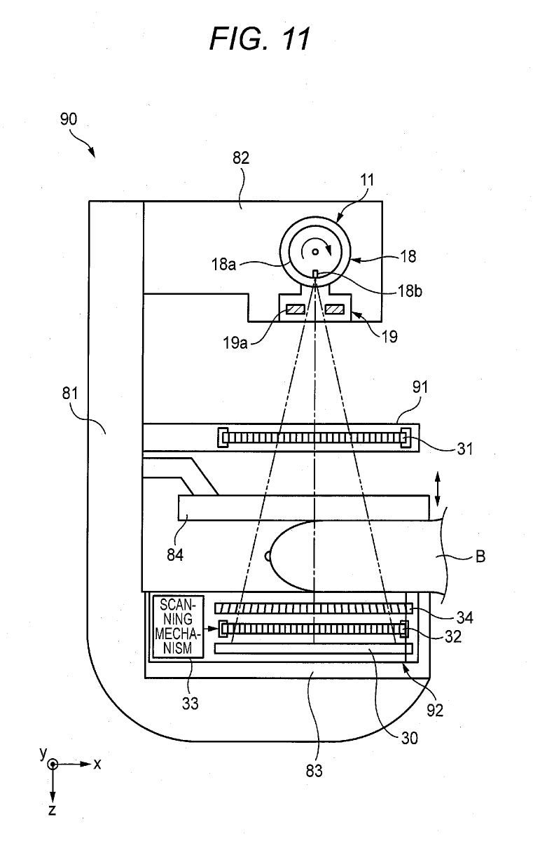

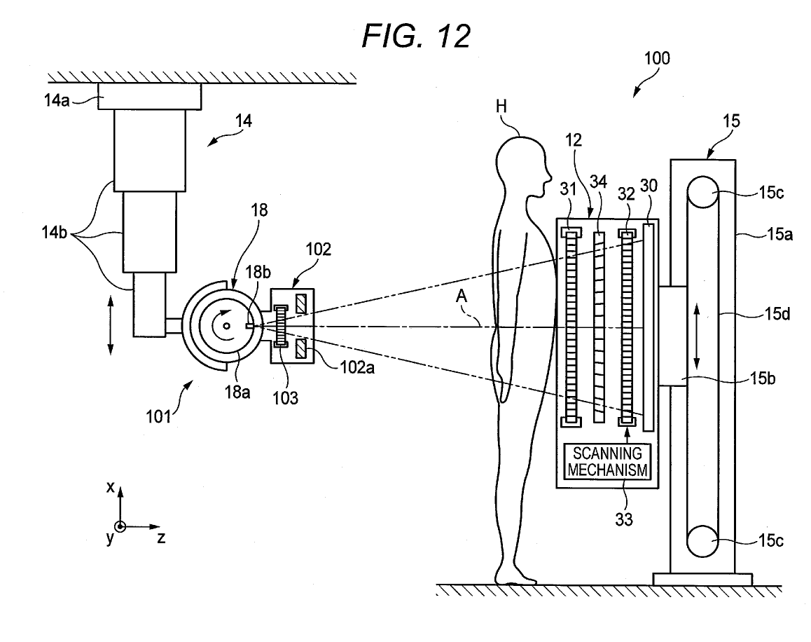

FIG. 11 shows a modified embodiment of the radiographic system of FIG. 10.

A mammography apparatus 90 shown in FIG. 11 is different from the mammography apparatus 80 in that the first absorption type grating 31 is provided between the X-ray source 11 and the compression plate 84. The first absorption type grating 31 is accommodated in a grating accommodation unit 91 that is connected to the arm member 81. An imaging unit 92 is configured by the FPD 30, the second absorption type grating 32 and the scanning mechanism 33.

Like this, even when the subject (breast) B is positioned between the first absorption type grating 31 and the second absorption type grating 32, the projection image (G1 image) of the first absorption type grating 31, which is formed at the position of the second absorption type grating 32, is deformed by the subject B. Accordingly, also in this case, it is possible to detect the moiré fringe, which is modulated due to the subject B, by the FPD 30. That is, also with the mammography apparatus 90, it is possible to obtain the phase contrast image of the subject B by the above-described principle.

In the mammography apparatus 90, since the X-ray whose radiation dose has been substantially halved by the shielding of the first absorption type grating 31 is irradiated to the subject B, it is possible to decrease the radiation exposure amount of the subject B about by half, compared to the above mammography apparatus 80. In the meantime, like the mammography apparatus 90, the configuration in which the subject is arranged between the first absorption type grating 31 and the second absorption type grating 32 can be applied to the above X-ray imaging system 10.

Preferably, for an imaging technique in which the scattered ray highly influences, the imaging is performed by using the anti-scatter grating 34, and for an imaging technique in which the scattered ray less influences, the imaging is performed without using the anti-scatter grating 34, from a standpoint of exposure reduction. As the imaging technique in which the scattered ray highly influences, an imaging for a thick part (refer to FIG. 1) such as waist, an imaging in a body width direction or an imaging of representing a faint contrast such as lung or breast (FIGS. 10 and 11) may be exemplified. In the meantime, as the imaging technique in which the scattered ray less influences, an imaging for a thin part such as finger or toe may be exemplified. Therefore, it is preferable that the anti-scatter grating 34 can retreat from the X-ray irradiation field. For example, in the housing of the imaging unit 12 accommodating the anti-scatter grating 34, the anti-scatter grating 34 is movably supported in one direction (for example, y direction) in the plane orthogonal to the optical axis A of the X-ray irradiated from the X-ray source 11 and the anti-scatter grating 34 is advanced and retreated in the one direction by an appropriate driving mechanism, and for the imaging technique in which the scattered ray less influences, the anti-scatter grating 34 is retreated from the X-ray irradiation field by the driving mechanism. Alternatively, by detaching the anti-scatter grating 34 from the housing of the imaging unit 12 to the outside, the anti-scatter grating 34 may be retreated from the X-ray irradiation field.

FIG. 12 shows another example of the radiographic system for illustrating an illustrative embodiment of the invention.

A radiographic system 100 shown in FIG. 12 is different from the radiographic system 10 of the first embodiment in that a multi-slit 103 is provided to a collimator unit 102 of an X-ray source 101. Since the other configurations are the same as the above X-ray imaging system 10, the descriptions thereof are omitted.

In the above X-ray imaging system 10, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In the X-ray imaging system 100 of this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation emitted from the X-ray source 11, thereby reducing the effective focus size in the x direction and forming a plurality of light sources with narrow focus (disperse light sources) in the x direction.

It is necessary to set a grating pitch p3 of the multi-slit 103 so that it satisfies a following equation (19), when a distance from the multi-slit 103 to the first absorption type grating 31 is L₃.

$$\begin{matrix}[ equation 19 ] & \\ {p}_{3} = \frac{{L}_{3}}{{L}_{2}} {p}_{2} & ( 19 )\end{matrix}$$

The equation (19) is a geometrical condition so that the projection images (G1 images) of the X-rays, which are emitted from the respective point light sources dispersedly formed by the multi-slit 103, by the first absorption type grating 31 coincide (overlap) at the position of the second absorption type grating 32.

Also, since the position of the multi-slit 103 is substantially the X-ray focus position, the grating pitch p₂ and the interval d₂ of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Also, in this illustrative embodiment, in order to secure a length V of the effective field of view in the x direction on the detection surface of the FPD 30, when a distance from the multi-slit 103 to the detection surface of the FPD 30 is L′, the thickness h₁, h₂ of the X-ray shield units 31b, 32b of the first and second absorption type gratings 31, 32 are determined to satisfy following equations (22) and (23).

$$\begin{matrix}[ equation 22 ] & \\ {h}_{1} \leq \frac{{L}^{′}}{V / 2} {d}_{1} & ( 22 ) \\ [ equation 23 ] & \\ {h}_{2} \leq \frac{{L}^{′}}{V / 2} {d}_{2} & ( 23 )\end{matrix}$$

The equation (21) is a geometrical condition so that the projection images (G1 images) of the X-rays by the first absorption type grating 31, which are emitted from the respective light sources with narrow focus dispersedly formed by the multi-slit 103, coincide (overlap) at the position of the second absorption type grating 32.

Like this, the G1 images based on the light sources with narrow focus formed by the multi-slit 103 overlap, so that it is possible to improve the quality of the phase contrast image without lowering the X-ray intensity. The above multi-slit 103 can be applied to any of the X-ray imaging systems.

In the above illustrative embodiments, as described above, the phase contrast image is based on the refracted component of the X-ray in the periodic arrangement direction (x direction) of the X-ray shield units 31b, 32b of the first and second absorption type gratings 31, 32 and the refracted component in the extending direction (y direction) of the X-ray shield units 31b, 32b is not reflected thereto. That is, a part outline following the direction (when running at right angle, y direction) intersecting with the x direction is represented, as the phase contrast image based on the refracted component of the x direction, through the grating surface that is the xy plane, and a part outline following the x direction without intersecting with the x direction is not represented as the phase contrast image of the x direction. That is, there is a part that cannot be represented depending on the shape and direction of the part to be the subject H. For example, when a direction of a load surface of the articular cartilage of a knee is made to match the y direction of the xy directions that are the in-plane directions of the grating, a part outline adjacent to the load surface (yz plane) following the y direction is sufficiently represented but the tissue (for example, tendon, ligament and the like) around the cartilage, which intersects with the load surface and substantially extends along the x direction, is not sufficiently represented. By moving the subject H, it is possible to capture the insufficiently represented part again. However, the burdens of the subject H and the operator are increased and it is difficult to secure the position reproducibility with the re-captured image.

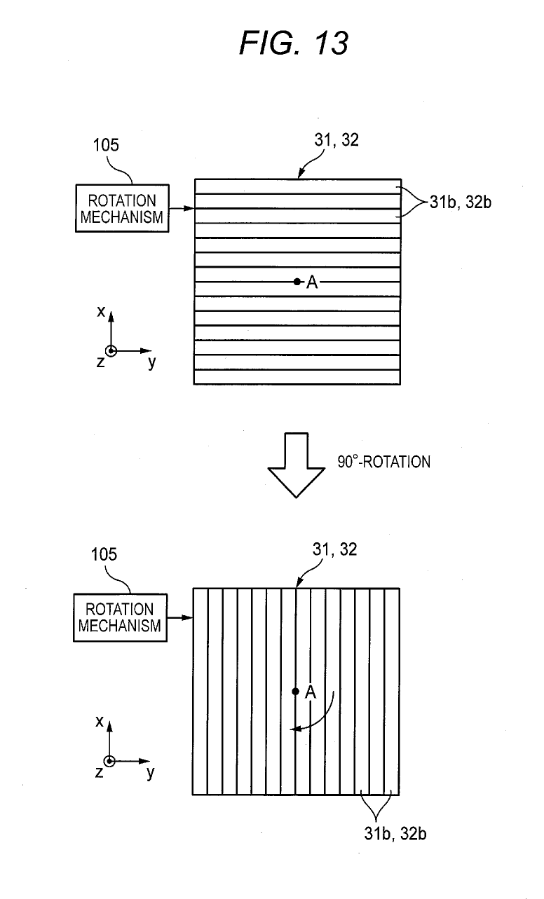

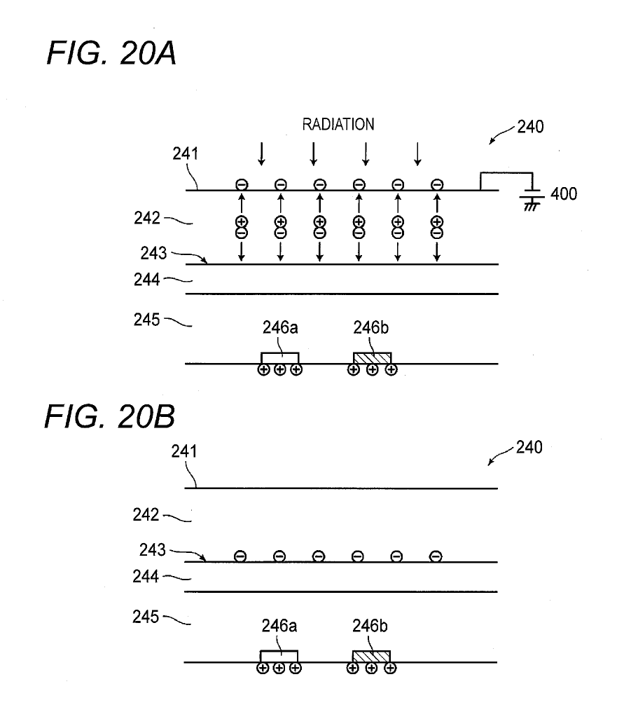

Accordingly, as another example, as shown in FIG. 13, a configuration is also preferable in which a rotation mechanism 105, which integrally rotates the first and second absorption type gratings 31, 32 by an arbitrary angle from a first direction (which is a direction along which the extending direction of the X-ray shield units 31b, 32b follow the y direction) shown in FIG. 13A to a second direction (which is a direction along which the extending direction of the X-ray shield units 31b, 32b follow the x direction) shown in FIG. 13B about an imaginary line (the optical axis A of the X-ray) orthogonal to centers of the grating surfaces of the first and second absorption type gratings 31, 32, is provided and the phase contrast images are respectively generated at each of the first and second directions. By doing so, it is possible to solve the above problem of the position reproducibility. Meanwhile, in FIG. 13A, the first direction of the first and second gratings 31, 32 is shown which is a direction along which the extending direction of the X-ray shield units 31b, 32b follows the y direction, and in FIG. 13B, the second direction of the first and second gratings 31, 32 is shown in which the state of FIG. 20A is 90°-rotated and thus the extending direction of the X-ray shield units 31b, 32b follows the x direction. However, the rotating angles of the first and second gratings are arbitrary. In addition to the first and second directions, two or more rotation operations such as third and fourth directions may be performed and the phase contrast images may be generated at the respective directions.

In the meantime, the rotation mechanism 105 may integrally rotate only the first and second absorption type gratings 31, 32 separately from the FPD 30 or integrally rotate the FPD 30 together with the first and second absorption type gratings 31, 32. Furthermore, when the multi-slit 103 is provided, the multi-slit 103 and the collimator 109 or the radiation source having the multi-slit and the collimator integrated thereto are rotated so that the rotation matches the first and second absorption type gratings 31, 32. The generation of the phase contrast images at the first and second directions by using the rotation mechanism 105 can be applied to any of the above illustrative embodiments.

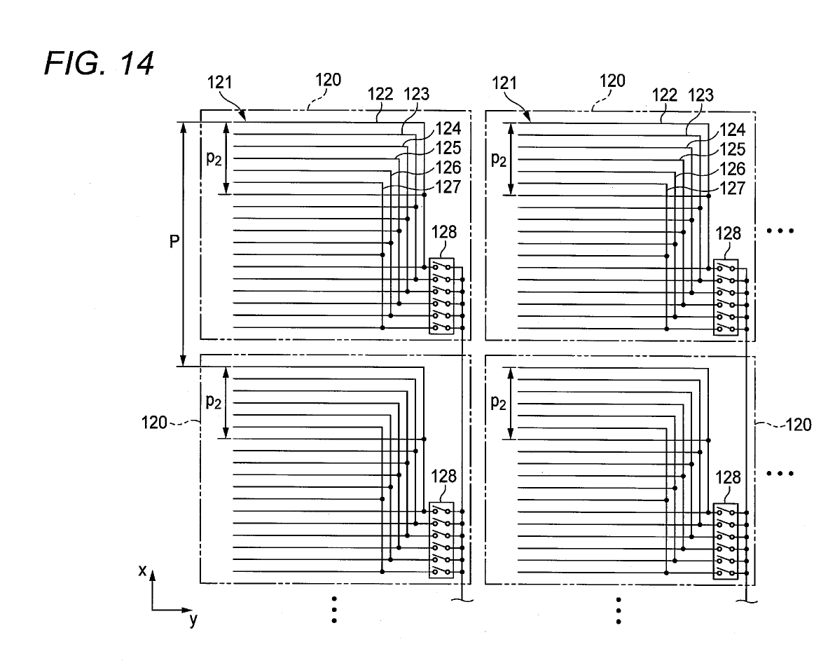

FIG. 14 shows another example of a configuration of the radiographic system for illustrating an illustrative embodiment of the invention, which is a partially enlarged view of a configuration of the X-ray image detector.

In each of the above illustrative embodiments, the second absorption type grating is provided separately from the FPD. However, the FPD of each illustrative embodiment may have a grating pattern by using the X-ray image detector that is disclosed in JP 2009-133823A, without using the second absorption type grating as the above-described grating pattern.

The X-ray image detector is a direct conversion type that includes a conversion layer, which converts the X-ray into charges, and a charge collection electrode, which collects the charges converted by the conversion layer, for each pixel. The charge collection electrode has a plurality of linear electrode groups each of which consists of a plurality of linear electrodes, which extend in a first direction, are arranged with a pitch substantially coinciding with the fringe pattern period of the radiological image formed by the first grating 31 and are electrically connected to each other. The linear electrode groups are arranged with the positions thereof being deviated with a pitch shorter than a pitch of the linear electrodes so that the phases thereof are different from each other. Here, the grating pattern is configured by each of the linear electrode groups.

The X-ray image detector is configured as described above, so that the second absorption type grating is not required. As a result, it is possible to reduce the costs and to make the imaging unit further smaller. Also, since it is possible to acquire the fringe images having a plurality of phase components by one imaging, the physical scanning for the fringe scanning is not required.

As shown in FIG. 14, pixels 120 are two-dimensionally arranged with a constant pitch in the x and y directions. Each pixel 120 is formed with a charge collection electrode 121 for collecting charges converted by a conversion layer that converts the X-ray into charges. The charge collection electrode 121 has first to sixth linear electrode groups 122 to 127. The respective linear electrode groups are offset by π/3 with respect to a phase of an arrangement period of the linear electrodes. Specifically, when a phase of the first linear electrode group 122 is 0, a phase of the second linear electrode group 123 is π/3, a phase of the third linear electrode group 124 is 2π/3, a phase of the fourth linear electrode group 125 is π, a phase of the fifth linear electrode group 126 is 4π/3 and a phase of the sixth linear electrode group 127 is 5π/3.

In each of the first to sixth linear electrode groups 122 to 127, the linear electrodes extending in the y direction are periodically arranged with a predetermined pitch p₂ in the x direction. A relation of a substantial pitch p₂′ (a substantial pitch after the manufacturing) of the arrangement pitch p₂ of the linear electrodes, a pattern period p₁′ of the G1 image at a position (a position of the X-ray image detector) of the charge collection electrode 121 and an arrangement pitch P of the pixels 120 in the x direction is required to satisfy the equation (10), based on the period T of the moiré fringe expressed by the equation (9) and to satisfy the equation (11), like the above illustrative embodiments.

Also, each of the pixels 120 is provided with a switch group 128 for reading out the charges collected by the charge collection electrode 121. The switch group 128 consists of TFT switches each of which is provided to the first to sixth linear electrode groups 121 to 126, respectively. The charges collected by the first to sixth linear electrode groups 121 to 126 are individually read out under control of the switch groups 128, so that it is possible to acquire six fringe images having different phases by one imaging and to generate the phase contrast image based on the six fringe images.

By using the X-ray image detector having the above configuration, the second absorption type grating is not necessary for the imaging unit. As a result, it is possible to reduce the costs and to make the imaging unit further smaller. Also, in this illustrative embodiment, since it is possible to acquire the fringe images having a plurality of phase components by one imaging, the physical scanning for the fringe scanning is not required, so that the scanning mechanism can be excluded. Meanwhile, regarding the configuration of the charge collection electrodes, the other configuration as disclosed in JP 2009-133823A may be used instead of the above configuration.

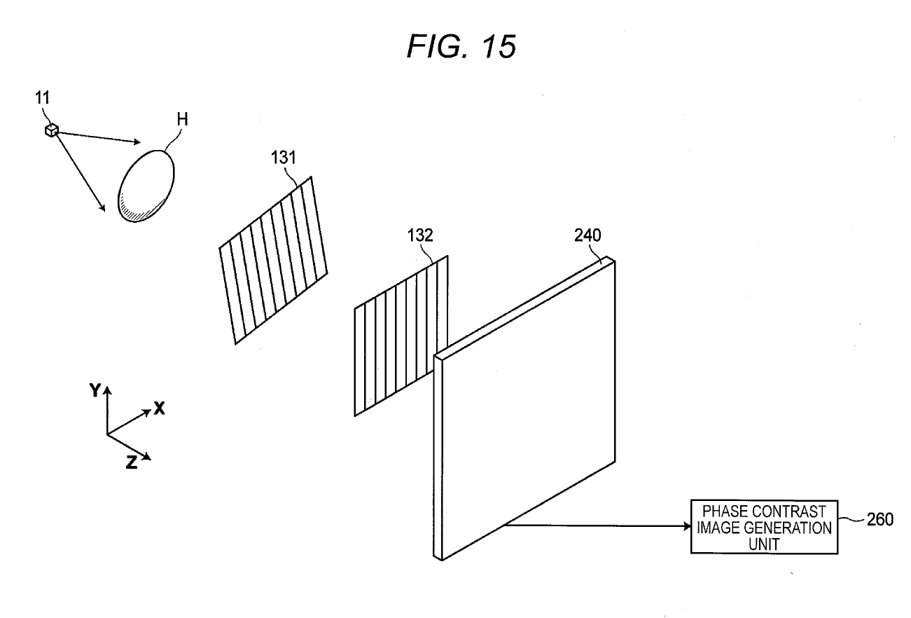

In the below, an example of a configuration of another X-ray imaging system for illustrating an illustrative embodiment of the invention is described. FIG. 15 shows a schematic configuration of a radiological phase image capturing apparatus of this illustrative embodiment.

An X-ray phase image capturing system of this illustrative embodiment has a first grating 131 that enables the X-ray emitted from the X-ray source 11 to pass therethrough and thus forms a first period pattern image, a second grating 132 that modulates an intensity of the first period pattern image formed by the first grating 131 and thus forms a second period pattern image, an X-ray image detector (radiological image detector) 240 that detects the second period pattern image formed by the second grating 132 and a phase contrast image generation unit 260 that acquires a fringe image, based on the second period pattern image detected by the X-ray image detector 240, and generates a phase contrast image, based on the acquired fringe image. In the meantime, the phase contrast image generation unit 260 configures a part of the process of the control device 20 in the console 13 (refer to FIG. 2).

The X-ray source 11 irradiates the X-ray toward the subject H and has a spatial coherence that can generate a Talbot interference effect when irradiating the X-ray to the first grating 131. For example, a micro focus X-ray tube or plasma X-ray source in which a size of an emitting point of the X-ray is small may be used. Also, when an X-ray source having a relatively large emitting point of the X-ray (so-called, focus size) is used, which is used in the typical medical field, a multi-slit having a predetermined pitch (for example, the above multi-slit 103) may be provided between the X-ray source 11 and the first grating 131.

Preferably, the first grating 131 is a phase modulation type grating that provides the irradiated X-ray with phase modulation of about 90 degrees or about 180 degrees. For example, when the X-ray shield unit is made of gold, the thickness h₁ that is necessary in an X-ray energy area for typical medical diagnosis is 1 μm to several μm. Also, an amplitude modulation type grating may be used as the first grating 131.

In the meantime, the second grating 132 is preferably an amplitude modulation type grating.

Here, when the X-ray irradiated from the X-ray source 11 is a cone beam, rather than a parallel beam, a self-image of the first grating 131, which is formed as the X-ray passes through the first grating 131, is enlarged in proportion to the distance from the X-ray source 11. In this illustrative embodiment, a grating pitch P₂ and an interval d₂ of the second grating 132 are determined so that the slits of the second grating substantially coincide with a period pattern of the bright parts of the self-image of the first grating 131 at the position of the second grating 132. That is, when a distance from the focus of the X-ray source 11 to the first grating 131 is L₁ and a distance from the first grating 131 to the second grating 132 is L₂, the grating pitch P₂ and the interval d₂ of the second grating 132 are determined so as to satisfy the equations (1) and (2). Meanwhile, d₁ and d₂ may be determined independently.

In the meantime, when the X-ray irradiated from the X-ray source 11 is a parallel beam, the grating pitch P₂ and the interval d₂ of the second grating 132 are determined so that P₂=P₁ and d₂=d₁.

The X-ray image detector 240 detects, as an image signal, an image that is obtained as the self-image of the first grating 131, which is formed by the X-ray incident onto the first grating 131, is intensity-modulated by the second grating 132. In this illustrative embodiment, as the X-ray image detector 240, a so-called optical reading type X-ray image detector is used which is a direct conversion type X-ray image detector and reads out an image signal as the linear reading light is scanned thereto.

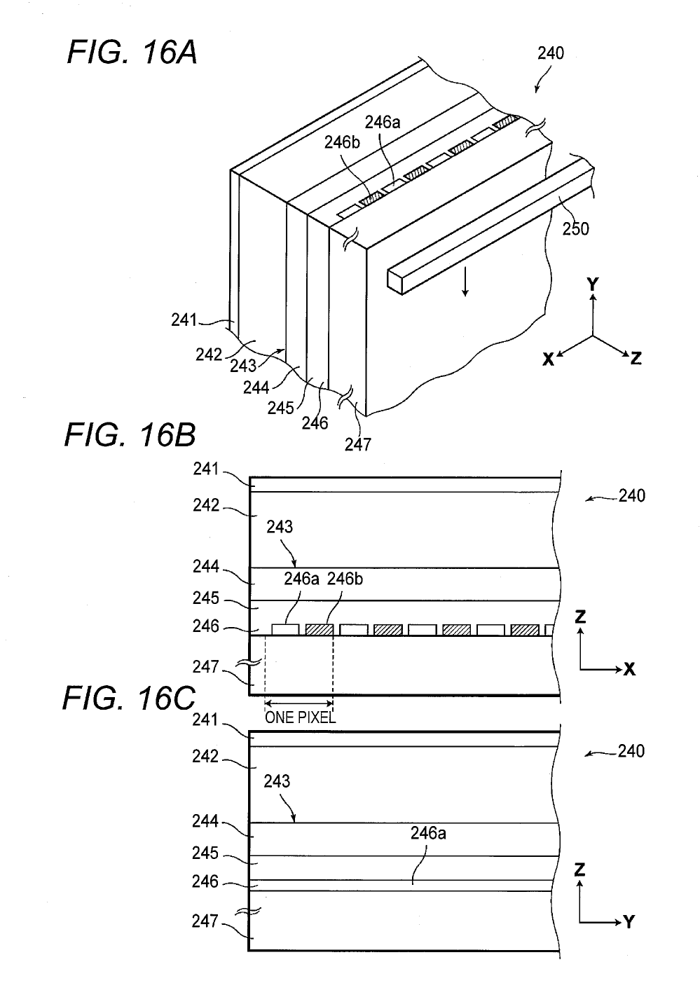

FIG. 16A is a perspective view of the X-ray image detector 240 of this illustrative embodiment, FIG. 16B is a sectional view taken along an XZ plane of the X-ray image detector shown in FIG. 16A, and FIG. 16C is a sectional view taken along a YZ plane of the X-ray image detector shown in FIG. 16A.

As shown in FIGS. 16A to 16C, the X-ray image detector 240 of this illustrative embodiment is configured by sequentially stacking a first electrode layer 241 that enables the X-ray to pass therethrough, a photoconductive layer 242 for record that generates charges as the X-ray having passed through the first electrode layer 241 is irradiated thereto, a charge transport layer 244 that functions as an insulator for a charge having one polarity of the charges generated in the photoconductive layer 242 for record and functions as a conductor for a charge having the other polarity, a photoconductive layer 245 for reading that generates charges as the reading light is illuminated thereto and a second photoconductive layer 246. An electric accumulation part 243 that accumulates the charges generated in the photoconductive layer 242 for record is formed near an interface between the photoconductive layer 242 for record and the charge transport layer 243. In the meantime, the respective layers are sequentially formed from the second electrode layer 246 on a glass substrate 247.

As the first electrode layer 241, any material may be used inasmuch as the X-ray can pass therethrough. For example, a Nesa film (SnO₂), ITO (Indium Tin Oxide), IZO (Indium Zinc Oxide), an IDIXO (Idemitsu Indium X-metal Oxide; Idemitsu Kosan Co., Ltd.) that is an amorphous type light transmissive oxide film, and the like may be used with a thickness of 50 to 200 nm. Also, Al or Au having a thickness of 100 nm may be used.

As the photoconductive layer 242 for record, any material may be used inasmuch as it generates the charges as the X-ray is irradiated thereto. For example, a material having a-Se as a main component may be used which has relatively high quantum efficiency regarding the X-ray and high dark resistance. It is appropriate that a thickness thereof is 10 μm to 1500 μm. Particularly, for the mammography application, the thickness is preferably 150 μm to 250 μm, and for the general imaging application, the thickness is preferably 500 μm to 1200 μm.

As the charge transport layer 244, the larger a difference between the mobility of the charges that are charged in the first electrode layer 241 in recording an X-ray image and the mobility of the charges having a reverse polarity thereto, the better (for example, the difference is 10² or larger, preferably 10³ or larger). For example, an organic-based compound such as poly N-vinylcarbazole (PVK), N,N′-diphenyl-N,N′-bis(3-methylphenyl)-[1,1′-biphenyl]-4,4′-diamine (TPD), discotic liquid crystal and the like, a disperse material of TPD polymer (polycarbonate, polystyrene, PVK) or a semiconductor material such as a-Se having Cl of 10 to 200 ppm doped therein and As₂Se₃ is appropriate. A thickness of about 0.2 to 2 μm is appropriate.

As the photoconductive layer 245 for reading, any material may be used inasmuch as it exhibits the conductivity as the reading light is irradiated thereto. For example, a photoconductive material having, as a main component, at least one of a-Se, Se—Te, Se—As—Te, metal-free phthalocyanine, metal phthalocyanine, MgPc (Magnesium phthalocyanine), VoPc (phase II of Vanadyl phthalocyanine) and CuPc (Cupper phthalocyanine) is appropriate. A thickness of about 5 to 20 μm is appropriate.

The second electrode layer 246 has a plurality of transparent linear electrodes 246a that enables the reading light to pass therethrough and a plurality of light-shielding linear electrodes 246b that shields the reading light. The transparent linear electrode 246a and the light shielding linear electrode 246b continuously extend linearly from one end portion of an image forming area of the X-ray image detector 240 to the other end portion. As shown in FIGS. 16A and 16B, the transparent linear electrodes 246a and the light shielding linear electrodes 246b are alternately arranged in parallel with each other at a predetermined interval.

The transparent linear electrode 246a is made of a material that enables the reading light to pass therethrough and has conductivity. For example, like the first electrode layer 241, ITO, IZO or IDIXO may be used. A thickness thereof is about 100 to 200 nm.

The light-shielding linear electrode 246b is made of a material that shields the reading light and has conductivity. For example, a combination of the transparent conductive material and a color filter may be used. A thickness of the transparent conductive material is about 100 to 200 nm.

In the X-ray image detector 240 of this illustrative embodiment, as specifically described later, one set of the transparent linear electrode 246a and the light-shielding linear electrode 246b, which are adjacent to each other, is used to read out an image signal. That is, as shown in FIG. 16B, an image signal of one pixel is read out by one set of the transparent linear electrode 246a and the light-shielding linear electrode 246b. In this illustrative embodiment, the transparent linear electrode 246a and the light-shielding linear electrode 246b are arranged so that one pixel becomes about 50 μm.

The X-ray phase image capturing apparatus of this illustrative embodiment has, as shown in FIG. 16A, a linear reading light source 250 that extends in a direction (X direction) orthogonal to the extending direction of the transparent linear electrode 246a and the light-shielding linear electrode 246b. In this illustrative embodiment, the linear reading light source 250 includes a light source such as LED (Light Emitting Diode), LD (Laser Diode) and the like and a predetermined optical system and is configured to illuminate the linear reading light having a width of about 10 μm toward the X-ray image detector 240. The linear reading light source 250 is moved in the extending direction (Y direction) of the transparent linear electrode 246a and the light-shielding linear electrode 246b by a predetermined moving mechanism (not shown). By the moving, the X-ray image detector 240 is scanned by the linear reading light emitted from the linear reading light source 250, so that an image signal is read out. The readout operation of the image signal will be specifically described in the below.

In order to enable the configuration having the X-ray source 11, the first grating 131, the second grating 132 and the X-ray image detector 240 to function as a Talbot interferometer, some conditions should be further satisfied. The conditions are described in the below.

First, grid surfaces of the first grating 131 and the second grating 132 should be parallel with the X-Y plane shown in FIG. 15.

Also, a distance Z₂ (Talbot interference distance Z) between the first grating 131 and the second grating 132 should substantially satisfy a following equation (24) when the first grating 131 is a π/2 phase grating.

$$\begin{matrix}[ equation 24 ] & \\ {Z}_{2} = ( m + \frac{1}{2} ) \frac{{p}_{1} {p}_{2}}{λ} & ( 24 )\end{matrix}$$

Here, λ is a wavelength of the X-ray (typically, effective wavelength), m is a zero (0) or positive integer, P₁ is a grating pitch of the first grating 131 and P₂ is a grating pitch of the second grating 132.

Also, when the first grating 131 is a it phase grating, the Talbot interference distance Z should substantially satisfy a following equation (25). m is a zero (0) or positive integer, P₁ is a grating pitch of the first grating 131 and P₂ is a grating pitch of the second grating 132. Also, when the first grating 131 is an amplitude modulation type grating, the above equation (3) should be substantially satisfied.

$$\begin{matrix}[ equation 25 ] & \\ {Z}_{2} = ( m + \frac{1}{2} ) \frac{{p}_{1} {p}_{2}}{2 λ} & ( 25 )\end{matrix}$$

Also, it is necessary that the thickness h₁, h₂ of the first and second gratings 131, 132 should be set to satisfy the equations (7) and (8) described with respect to the first and second gratings 31, 32.

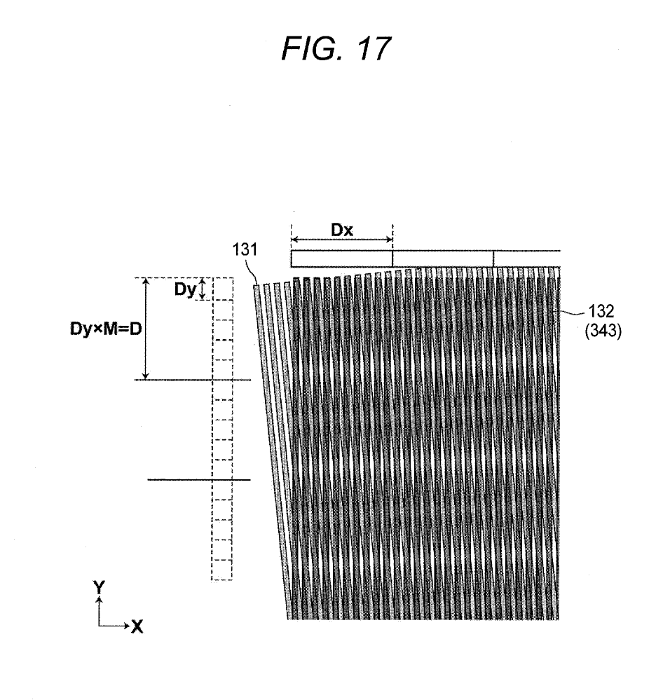

In the X-ray phase image capturing apparatus of this illustrative embodiment, as shown in FIG. 17, the first grating 131 and the second grating 132 are arranged so that the extending direction of the first grating 131 and the extending direction of the second grating 132 are relatively inclined. Regarding the first grating 131 and the second grating 132 arranged as described above, a main pixel size Dx of a main scanning direction (X direction in FIG. 16) and a sub-pixel size Dy of a sub-scanning direction of each pixel of the image signals detected by the X-ray image detector 240 have a relation as shown in FIG. 17.

The main pixel size Dx is determined by an arrangement pitch of the transparent linear electrodes 246a and the light-shielding linear electrodes 246b of the X-ray image detector 240, as described above, and is set to be 50 μm in this illustrative embodiment. Also, the sub-pixel size Dy is determined by the width of the linear reading light that is illuminated toward the X-ray image detector 240 by the linear reading light source 250, and is set to be 10 μm in this illustrative embodiment.

In this illustrative embodiment, a plurality of fringe images is obtained and a phase contrast image is generated based on the fringe images. When the number of the obtained fringe images is M, the first grating 131 is inclined relative to the second grating 132 so that the M sub-pixel sizes Dy become one image resolution D of the phase contrast image in the sub-scanning direction.

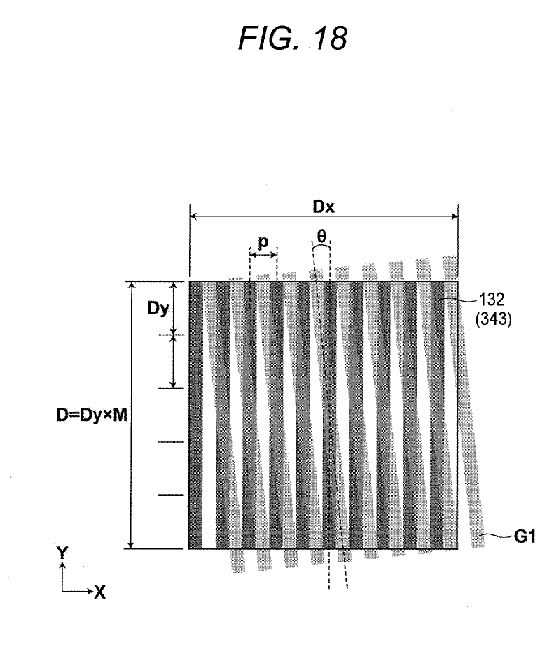

Specifically, as shown in FIG. 18, when the pitch of the second grating 132 and the pitch of a period pattern image (hereinafter, referred to as a self-image G1 of the first grating 131) formed at the position of the second grating 132 by the first grating 131 are indicated with p, a relative rotating angle of the self-image of the first grating 131 relative to the second grating 132 in the X-Y plane is indicated with θ and an image resolution of the phase contrast image in the sub-scanning direction is indicated with D (=Dy×M), the rotating angle θ is set to satisfy a following equation (26), so that the phases of the self-image G1 of the first grating 131 and the second grating 132 are offset by an n period with respect to a length of the image resolution D in the sub-scanning direction. Meanwhile, in FIG. 18, a case where M=5 and n=1 is shown.

$$\begin{matrix}[ equation 26 ] & \\ θ = arctan \{ n \times \frac{p}{D} \} & ( 26 )\end{matrix}$$

here, n is an integer except for zero (0) and a multiple of M.

Accordingly, by each pixel of Dx×Dy that is obtained by M-dividing the image resolution D of the phase contrast image in the sub-scanning direction, it is possible to detect image signals that are obtained by M-dividing the intensity modulation of the n period of the self image of the first grating 131. In the example shown in FIG. 18, n=1. Thus, regarding the length of the image resolution D in the sub-scanning direction, the phases of the self-image G1 of the first grating 131 and the second grating 132 are offset by one period. More easily speaking, a range within which the self-image G1 of the first grating 131 passes through the second grating 132 of one period is changed over the length of the image resolution D in the sub-scanning direction.

Also, M=5. Thus, by each pixel of Dx×Dy, it is possible to detect the image signals that are obtained by five-dividing the intensity modulation of one period of the self-image of the first grating 131. That is, it is possible to respectively detect the image signals of the five different fringe images by each pixel of Dx×Dy. In the meantime, a method of acquiring the image signals of the five fringe images will be specifically described in the below.

Meanwhile, in this illustrative embodiment, as described above, Dx=50 μm, Dy=10 μm and M=5. Thus, the image resolution Dx of the phase contrast image in the main scanning direction and the image resolution D (=Dy×M) thereof in the sub-scanning direction are the same. However, it is not necessarily to make the image resolution Dx in the main scanning direction and the image resolution D in the sub-scanning direction same and an arbitrary main to sub ratio is possible.

Also, in this illustrative embodiment, M=5. However, M may be 3 or larger and may be any integer except for 5. Also, in this illustrative embodiment, n=1. However, n may be any integer except for 1 inasmuch as it is an integer except for zero (0). That is, when n is a negative integer, the rotation is made in the opposite direction to that of the above-described example, and n may be an integer except for ±1, so that the intensity modulation of n period may be made. However, when n is a multiple of M, the phases of the self image of the first grating 131 and the second grating 132 are the same between the M pixels Dy of one set in the sub-scanning direction. As a result, since the M different fringe images are not made, a case where n is a multiple of M is excluded.

Also, regarding the rotating angle θ of the self image of the first grating 131 relative to the second grating 132, the first grating 131 may be rotated after the relative rotating angle of the X-ray image detector 240 and the second grating 132 is fixed.

For example, when p=5 μm, D=50 μm and n=1 in the equation (26), a theoretical rotating angle θ is about 5.7 degrees. Then, an actual rotating angle θ′ of the self-image of the first grating 131 relative to the second grating 132 can be detected by a pitch of the moiré by the self-image of the first grating 131 and the second grating 132, for example.

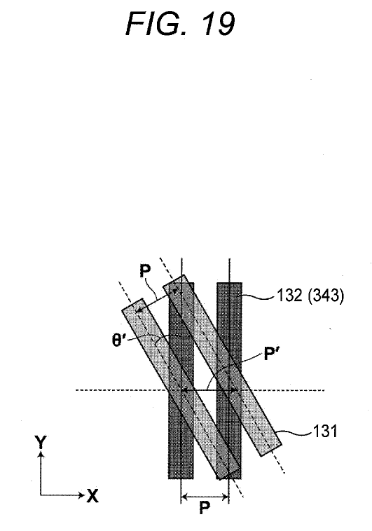

Specifically, as shown in FIG. 19, when the actual rotating angle is indicated with θ′ and a pitch of the apparent self-image in the x direction generated by the rotation is indicated with P′, the pitch Pm of the observed moiré is 1/Pm=|1/P′−1/P|. Thus, by substituting P′=P/cos θ′ in the above equation, the actual rotating angle θ′ can be calculated. In the meantime, the pitch Pm of the moiré may be calculated based on the image signals detected by the X-ray image detector 240.

Then, by comparing the theoretical rotating angle θ with the actual rotating angle θ′, the rotating angle of the first grating 131 may be manually or automatically adjusted as a difference of the rotating angles.

The phase contrast image generation unit 260 generates an X-ray phase contrast image, based on the image signals of the different fringe images of M types detected by the X-ray image detector 240.

In the below, the operations of the X-ray phase image capturing apparatus of this illustrative embodiment are described.

First, as shown in FIG. 15, the subject H is arranged between the X-ray source 11 and the first grating 131 and the X-ray is then emitted from the X-ray source 11. The X-ray penetrates the subject H and is then irradiated to the first grating 131. The X-ray irradiated to the first grating 131 is diffracted in the first grating 131, so that a Talbot interference image is formed at a predetermined distance from the first grating 131 in the optical axis direction of the X-ray.

The above is referred to as the Talbot effect. When the light wave passes through the first grating 131, a self-image of the first grating 131 is formed at a predetermined distance from the first grating 131. For example, when the first grating 131 is a π/2 phase grating, the self-image of the first grating 131 is formed at a distance that is determined by the equation (24) (by the equation (25) when the first grating is π phase grating or by the equation (3) when the first grating is an intensity modulation type grating). In the meantime, since a wave front of the X-ray incident onto the first grating 131 is distorted by the subject H, the self-image of the first grating 131 is correspondingly deformed.

Subsequently, the X-ray passes through the second grating 132. As a result, the deformed self-image of the first grating 131 is intensity-modulated by the superimposition with the second grating 132, so that it is detected, as an image signal reflecting the distortion of the wave front, by the X-ray image detector 240.

Here, the image detection and readout operations of the X-ray image detector 240 are described.

First, as shown in FIG. 20A, at a state in which the negative voltage is applied to the first electrode layer 241 of the X-ray image detector 240 by a high voltage power supply 400, the X-ray that has been intensity-modulated by the superimposition of the self-image of the first grating 131 and the second grating 132 is irradiated from the first electrode layer 241 of the X-ray image detector 240.

The X-ray irradiated to the X-ray image detector 240 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges thereof are accumulated, as latent image charges, in the electric accumulation part 243 that is formed at the interface between the photoconductive layer 242 for record and the charge transport layer 244 (refer to FIG. 20B).

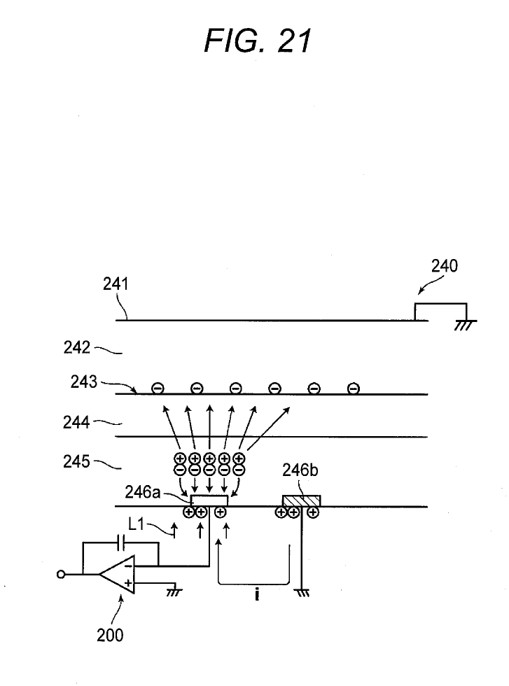

Then, as shown in FIG. 21, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 245 for reading. The positive charges generated in the photoconductive layer 245 for reading by the illumination of the reading light L1 pass through the charge transport layer 244 and are combined with the latent image charges in the electric accumulation part 243 and the negative charges are combined with the positive charges that are charged in the light-shielding linear electrode 246b through a charge amplifier 200 connected to the transparent linear electrode 246a.

As the negative charges generated in the photoconductive layer 245 for reading and the positive charges charged in the light-shielding linear electrode 246b are combined, the current flows in the charge amplifier 200 and is integrated and thus detected as an image signal.

The linear reading light source 250 is moved in the sub-scanning direction, so that the X-ray image detector 240 is scanned by the linear reading light L1. Thereby, the image signals are sequentially detected for each of the scan lines, which are illuminated by the linear reading light L1, in accordance with the above operations, and the detected image signals for each of the reading lines are sequentially input and stored in the phase contrast image generation unit 260.

The whole surface of the X-ray image detector 240 is scanned by the reading light L1, so that the image signals of a whole one frame are stored in the phase contrast image generation unit 260. Then, the phase contrast image generation unit 260 acquires the image signals of the five different fringe images, based on the stored image signals.

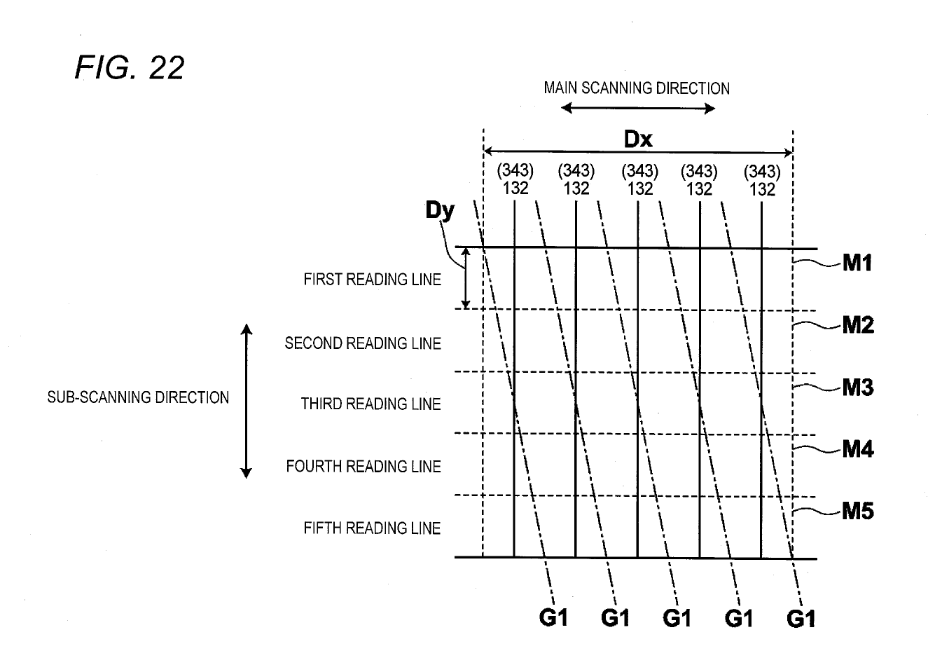

Specifically, in this illustrative embodiment, as shown in FIG. 18, the first grating 131 is inclined relatively to the second grating 132 so as to detect the image signals obtained by five-dividing the image resolution D of the phase contrast image in the sub-scanning direction and five-dividing the intensity-modulation of one period of the self-image of the first grating 131. Accordingly, as shown in FIG. 22, the image signal read out from a first reading line is acquired as a first fringe image signal M1, the image signal read out from a second reading line is acquired as a second fringe image signal M2, the image signal read out from a third reading line is acquired as a third fringe image signal M3, the image signal read out from a fourth reading line is acquired as a fourth fringe image signal M4 and the image signal read out from a fifth reading line is acquired as a fifth fringe image signal M5. In the meantime, the first to fifth reading lines shown in FIG. 22 correspond to the sub-pixel sizes Dy shown in FIG. 18, respectively.

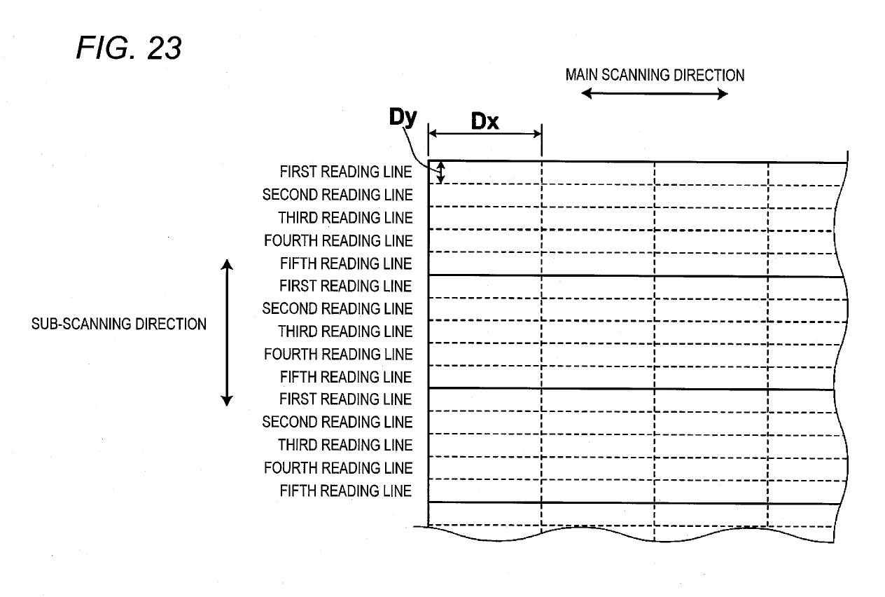

Also, in FIG. 22, the reading range of only Dx×(Dy×5) is shown. However, also for the other reading ranges, the first to fifth fringe image signals are acquired in the same manner. That is, as shown in FIG. 23, an image signal is acquired for each pixel line group consisting of a pixel line (reading line) every four pixel-interval in the sub-scanning direction, so that one fringe image signal of one frame is acquired. More specifically, an image signal of a pixel line group of a first reading line is acquired, so that a first fringe image signal of one frame is acquired, an image signal of a pixel line group of a second reading line is acquired, so that a second fringe image signal of one frame is acquired, an image signal of a pixel line group of a third reading line is acquired, so that a third fringe image signal of one frame is acquired, an image signal of a pixel line group of a fourth reading line is acquired, so that a fourth fringe image signal of one frame is acquired, and an image signal of a pixel line group of a fifth reading line is acquired, so that a fifth fringe image signal of one frame is acquired.

The first to fifth different fringe image signals are acquired as described above, and a phase contrast image is generated in the phase contrast image generation unit 260, based on the first to fifth fringe image signals.

Since the method of generating the phase contrast image in this illustrative embodiment is the same as that described with reference to the equations (12) to (18), the description thereof is omitted.

In the meantime, regarding the configuration in which the first grating 131 and the second grating 132 are inclined, it may be possible that both the first grating 131 and the second grating 132 are configured with the absorption type (amplitude modulation type) gratings and the radiation having passed through the slits are geometrically projected without reference to the Talbot interference effect. In this case, the interval d₁ of the first grating 131 and the interval d₂ of the second grating 132 are set to be sufficiently larger than the effective wavelength of the X-ray irradiated from the X-ray source 11 so that diffraction effect can be neglected. Therefore, it is possible to form an image following the form of the first grating 131 behind the first grating. For example, when tungsten is used as a target of the X-ray source and the tube voltage is 50 kV, the effective wavelength of the X-ray is about 0.4 Å. In this case, when the interval d₁ of the first grating 131 and the interval d₂ of the second grating 132 are set to be about 1 μm to 10 μm, most of the radiation is geometrically projected without being diffracted in the slits. The relation between the grating pitch P₁ of the first grating 131 and the grating pitch P₂ of the second grating 132 and the relation between the interval d₁ of the first grating 131 and the interval d₂ of the second grating 132 are the same as the above case where the first grating 131 is a phase modulation type grating. Also, the inclination of the first grating 131 to the second grating 132 is the same as the above illustrative embodiment and the generation of the phase contrast image is also the same as the above illustrative embodiment.

Meanwhile, in the above illustrative embodiment, regarding the X-ray image detector 240, a so-called optical reading type X-ray image detector in which an image signal is read out by the scanning of the reading light emitted from the linear reading light source 250 is used. However, the invention is not limited thereto. For example, as disclosed in JP 2002-26300A, an X-ray image detector using TFT switches in which a plurality of TFT switches is two-dimensionally arranged and image signals are read out as the TFT switches become on and off, an X-ray image detector using CMOSs, and the like may be used.

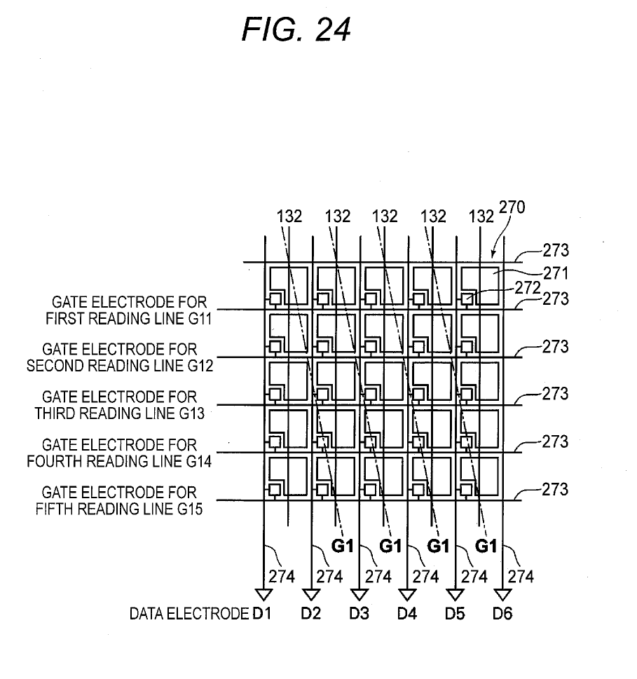

Specifically, in the X-ray image detector using TFT switches, as shown in FIG. 24, a plurality of pixel circuits 270, each of which has a pixel electrode 271 that collects charges photoelectrically converted in a semiconductor film by the irradiation of the X-ray and a TFT switch 272 that reads out, as an image signal, the charges collected by the pixel electrode 271, is two-dimensionally arranged. Also, the X-ray image detector using TFT switches has a plurality of gate electrodes 273 that is provided for each of pixel circuit lines and outputs a gate scanning signal for turning on and off the TFT switches 272 and a plurality of data electrodes 274 that is provided for each of pixel circuit column and outputs the charge signals read out from the respective pixel circuits 270. In the meantime, the detailed layer configuration of each pixel circuit 270 is the same as that disclosed in JP 2002-26300A.

Meanwhile, when the second grating 132 and the pixel circuit column (data electrode) are provided in parallel with each other, for example, one pixel circuit column corresponds to the main pixel size Dx described in the above illustrative embodiment and one pixel circuit line corresponds to the sub-pixel size Dy described in the above illustrative embodiment. The main pixel size Dx and the sub-pixel size Dy may be set to be about 50 μm.

Like the above illustrative embodiment, when M fringe images are used so as to generate a phase contrast image, the first grating 131 is inclined relatively to the second grating 132 so that the pixel circuit lines of M lines become one image resolution D of the phase contrast image in the sub-scanning direction. The specific rotating angle of the first grating 131 is calculated by the equation (26), like the above illustrative embodiment.

In the equation (26), when the rotating angle θ of the first grating 131 is set with M=5 and n=1, it is possible to detect an image signal, which is obtained by five-dividing the intensity modulation of one period of the self-image of the first grating 131, by one pixel circuit 270 shown in FIG. 24. That is, it is possible to respectively detect the image signals of the five different fringe images by the pixel circuit lines of five lines connected to the five gate electrodes 273 shown in FIG. 24. Meanwhile, in FIG. 24, one second grating 132 and self-image G1 are shown to correspond to one pixel circuit column. However, actually, a plurality of second gratings 132 and self-images may be provided for one pixel circuit column, which is not shown in FIG. 24.

Accordingly, an image signal, which is read out from the pixel circuit line connected to the gate electrode G11 for first reading line, is acquired as a first fringe image signal M1, an image signal, which is read out from the pixel circuit line connected to the gate electrode G12 for second reading line, is acquired as a second fringe image signal M2, an image signal, which is read out from the pixel circuit line connected to the gate electrode G13 for third reading line, is acquired as a third fringe image signal M3, an image signal, which is read out from the pixel circuit line connected to the gate electrode G14 for fourth reading line, is acquired as a fourth fringe image signal M4, and an image signal, which is read out from the pixel circuit line connected to the gate electrode G15 for fifth reading line, is acquired as a fifth fringe image signal M5.

The method of generating a phase contrast image based on the first to fifth fringe image signals is the same as the above illustrative embodiment. Meanwhile, as described above, when the sizes of one pixel circuit 270 in the main scanning direction and sub-scanning direction are 50 μm, the image resolution of the phase contrast image in the main scanning direction is 50 μm and the image resolution thereof in the sub-scanning direction is 50 μm×5=250 μm.

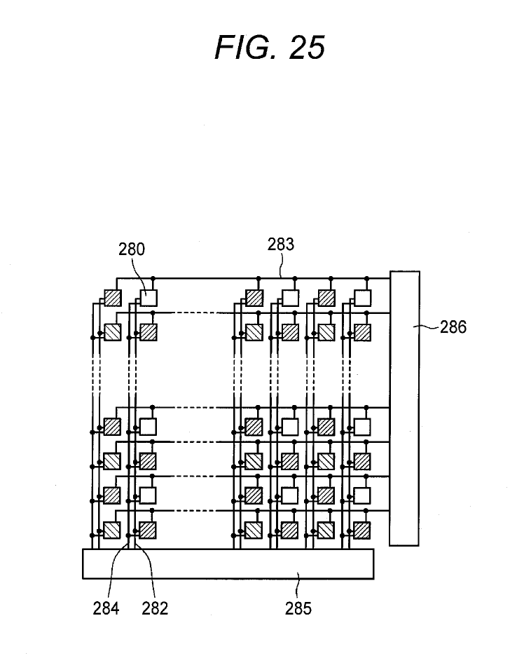

Also, in the X-ray image detector using CMOSs, a plurality of pixel circuits 280, each of which generates visible light as the X-ray is irradiated thereto and photoelectrically converts the visible light and thus detects a charge signal, is two-dimensionally arranged, as shown in FIG. 25, for example. The X-ray image detector using CMOSs has a plurality of gate electrodes 282 and reset electrodes 284 that are provided for each of pixel circuit lines and output a driving signal for driving a signal readout circuit included in the pixel circuit 280 and a plurality of data electrodes 283 that is provided for each of pixel circuit columns and outputs a charge signal read out from the signal readout circuit of each pixel circuit 280. In the meantime, a line selection scanning unit 285 that outputs a driving signal to the signal readout circuit is connected to the gate electrodes 282 and the reset electrodes 284 and a signal processing unit 286 that performs a predetermined process for the charge signals output from the respective pixel circuits is connected to the data electrodes 283.

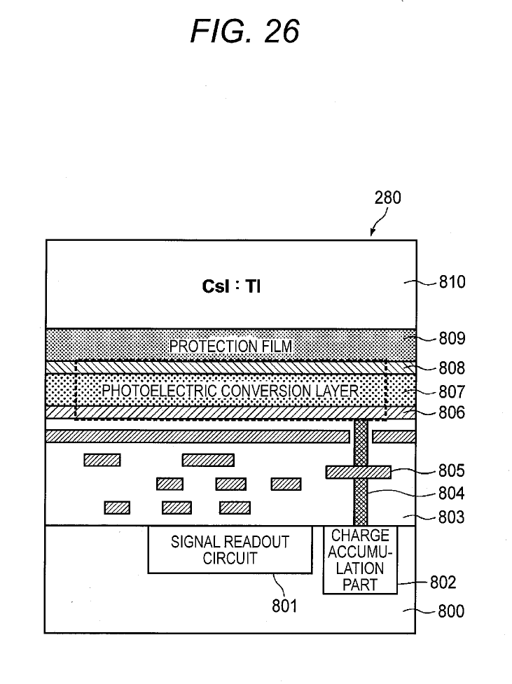

As shown in FIG. 26, each pixel circuit 280 has a lower electrode 806 that is formed above a substrate 800 via an insulation film 803, a photoelectric conversion film 807 that is formed on the lower electrode 806, an upper electrode 808 that is formed on the photoelectric conversion film 807, a protection film 809 that is formed on the upper electrode 808 and an X-ray conversion film 810 that is formed on the protection film 908.

The X-ray conversion film 810 is made of CsI:Tl that generates light having a wavelength of 550 nm as the X-ray is irradiated thereto, for example. A thickness thereof is preferably about 500 μm.

Since the upper electrode 808 should enable the light having a wavelength of 550 nm to be incident onto the photoelectric conversion film 807, it is made of a transparent conductive material regarding the incident light. Also, the lower electrode 806 is a thin film that is divided for each pixel circuit 280 and is formed of a transparent or opaque conductive material.

The photoelectric conversion film 807 is made of a photoelectric conversion material that absorbs light having a wavelength of 550 nm, for example and generates charges corresponding to the light. As the photoelectric conversion film, an organic semiconductor, an organic material including organic dye, an inorganic semiconductor crystal of a high absorption coefficient having a direct transition type band gap, and the like may be used in a single body or combination thereof.

By applying a predetermined bias voltage between the upper electrode 808 and the upper electrode 806, the one type charges of the charges generated in the photoelectric conversion film 807 are moved to the upper electrode 808 and the other type charges are moved to the lower electrode 806.

In the substrate 800 below the lower electrode 806, a charge accumulation part 802 that accumulates the charges moved to the lower electrode 806 is formed in correspondence to the lower electrode 806 and a signal readout circuit 801 that converts and outputs the charges accumulated in the charge accumulation part 802 into a voltage signal is formed.

The charge accumulation part 802 is electrically connected to the lower electrode 806 by a plug 804 that is formed to penetrate the insulation film 803 and is made of a conductive material. The signal readout circuit 801 is configured by a well-known CMOS circuit.

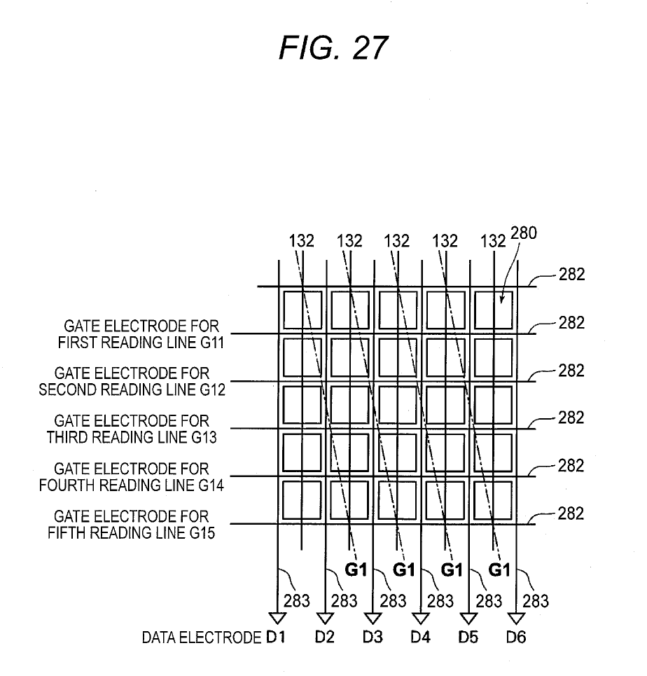

When the X-ray image detector using CMOSs as described above is mounted so that the second gratings 132 and the pixel circuit columns (data electrodes) are provided in parallel with each other, as shown in FIG. 27, one pixel circuit column corresponds to the main pixel size Dx described in the above illustrative embodiment and one pixel circuit line corresponds to the sub-pixel size Dy described in the above illustrative embodiment. In the X-ray image detector using CMOSs, the main pixel size Dx and the sub-pixel size Dy may be set to be about 10 μm, for example.

Like the above illustrative embodiment, when M fringe images are used so as to generate a phase contrast image, the first grating 131 is inclined relatively to the second grating 132 so that the pixel circuit lines of M lines become one image resolution D of the phase contrast image in the sub-scanning direction. The specific rotating angle of the first grating 131 is calculated by the equation (26), like the above illustrative embodiment.

In the equation (26), when the rotating angle θ of the first grating 131 is set with M=5 and n=1, it is possible to detect an image signal, which is obtained by five-dividing the intensity modulation of one period of the self-image of the first grating 131, by one pixel circuit 280 shown in FIG. 27. That is, it is possible to respectively detect the image signals of the five different fringe images by the pixel circuit lines of five lines connected to the five gate electrodes 282 shown in FIG. 27. Meanwhile, in FIG. 27, one second grating 132 and self-image G1 are shown to correspond to one pixel circuit column. However, actually, a plurality of second gratings 132 and self-images G1 may be provided for one pixel circuit column, which is not shown in FIG. 27.

Accordingly, like the X-ray image detector using TFT switches, an image signal, which is read out from the pixel circuit line connected to the gate electrode G11 for first reading line, is acquired as a first fringe image signal M1, an image signal, which is read out from the pixel circuit line connected to the gate electrode G12 for second reading line, is acquired as a second fringe image signal M2, an image signal, which is read out from the pixel circuit line connected to the gate electrode G13 for third reading line, is acquired as a third fringe image signal M3, an image signal, which is read out from the pixel circuit line connected to the gate electrode G14 for fourth reading line, is acquired as a fourth fringe image signal M4, and an image signal, which is read out from the pixel circuit line connected to the gate electrode G15 for fifth reading line, is acquired as a fifth fringe image signal M5.

The method of generating a phase contrast image based on the first to fifth fringe image signals is the same as the above illustrative embodiment. Meanwhile, as described above, when the sizes of one pixel circuit 280 in the main scanning direction and sub-scanning direction are 10 μm, the image resolution of the phase contrast image in the main scanning direction is 10 μm and the image resolution thereof in the sub-scanning direction is 10 μm×5=50 μm.

In the meantime, as described above, the X-ray image detector using TFT switches or X-ray image detector using CMOSs can be used. However, such X-ray image detectors have the square-shaped pixels. Thus, when the invention is applied thereto, the resolution in the sub-scanning direction is deteriorated, compared to the resolution in the main scanning direction. To the contrary, in the optical reading type X-ray image detector described in the above illustrative embodiment, the resolution Dx in the main scanning direction is limited by the width (direction perpendicular to the extending direction) of the linear electrode. However, in the sub-scanning direction, the resolution Dy is determined by the width of the reading light of the linear reading light source 250 in the sub-scanning direction and a product of the accumulation time of the charge amplifier 200 for each line and the moving speed of the linear reading light source 250. Although both the resolutions in the main and sub-scanning directions are typically several 10 μm, a design may be possible in which the resolution in the sub-scanning direction is increased with the resolution in the main scanning direction being kept. For example, such a design can be realized by decreasing the width of the linear reading light source 250 or lowering the moving speed thereof. Hence, the optical reading type X-ray image detector is more favorable.

Also, since it is possible to acquire the plurality of fringe image signals by one imaging, it is possible to use an accumulative fluorescent sheet or silver salt film as well as the semiconductor detector that can be immediately repeatedly used. In this case, the reading pixels in reading the accumulative fluorescent sheet or developed silver salt film correspond to pixels in the claims.

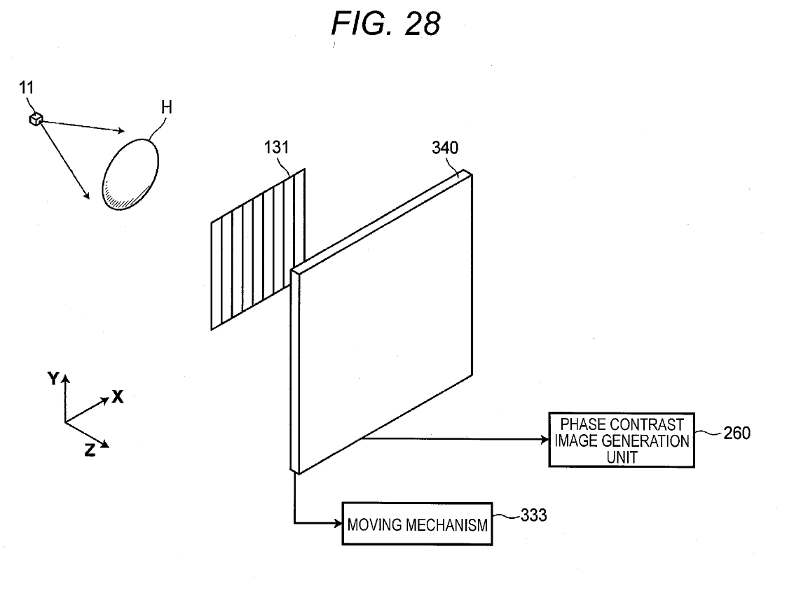

In the below, an example of a configuration of another X-ray imaging system for illustrating an illustrative embodiment of the invention is described. FIG. 28 shows a schematic configuration of the X-ray phase image capturing apparatus of this illustrative embodiment.

As shown in FIG. 28, the X-ray phase image capturing apparatus has a grating 131 that enables the X-ray emitted from the X-ray source 11 to pass therethrough and thus forms a period pattern image, an X-ray image detector (radiological image detector) 340 that detects the period pattern image formed by the grating 131 and performs an intensity modulation for the period pattern image, a moving mechanism 333 that moves the X-ray image detector 340 in a direction orthogonal to the extending direction of a linear electrode thereof, and a phase contrast image generation unit 260 that generates a phase contrast image, based on a fringe image that is obtained by performing the intensity modulation for the period pattern image in the X-ray image detector 340.

Also in this illustrative embodiment, a multi-slit (for example, the multi-slit 103 as described above) having a predetermined pitch may be provided between the X-ray source 11 and the first grating 131.

The X-ray image detector 340 detects a self-image of the grating 131 that is formed by the grating 131 as the X-ray passes through the grating 131, accumulates a charge signal corresponding to the self-image in a charge accumulation layer that is divided into a grating shape (which will be described later) to perform the intensity modulation for the self-image and to form a fringe image and outputs the generated fringe image as an image signal. As the X-ray image detector 340, in this illustrative embodiment, a so-called optical reading type X-ray image detector is used which is a direct conversion type X-ray image detector and reads out an image signal as the linear reading light is scanned thereto.

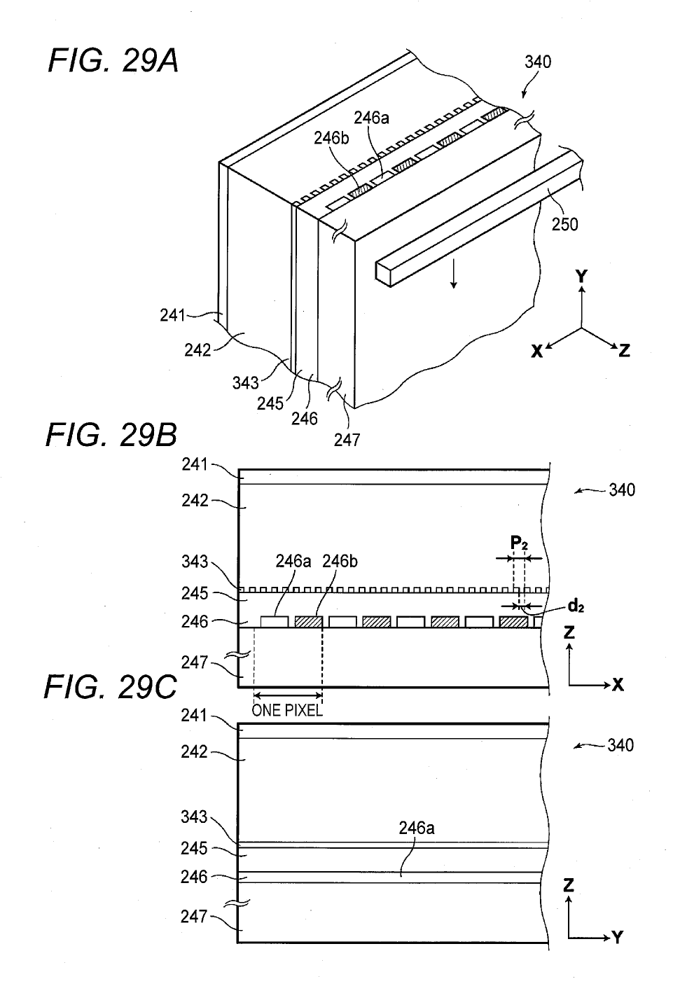

FIG. 29A is a perspective view of the X-ray image detector 340 of this illustrative embodiment, FIG. 29B is a sectional view taken along an XZ plane of the X-ray image detector shown in FIG. 29A, and FIG. 29C is a sectional view taken along a YZ plane of the X-ray image detector shown in FIG. 29A.

As shown in FIGS. 29A to 29C, the X-ray image detector 340 of this illustrative embodiment is configured by sequentially stacking a first electrode layer 241 that enables the X-ray to pass therethrough, a photoconductive layer 242 for record that generates charges as the X-ray having passed through the first electrode layer 241 is irradiated thereto, a charge accumulation layer 343 that functions as an insulator for a charge having one polarity of the charges generated in the photoconductive layer 242 for record and functions as a conductor for a charge having the other polarity, a photoconductive layer 245 for reading that generates charges as the reading light is irradiated thereto and a second electrode layer 246 in corresponding order. In the meantime, the respective layers are sequentially formed from the second electrode layer 246 on a glass substrate 247.

As the charge accumulation layer 343, any film that has an insulating property for a charge having a polarity to be accumulated can be used. For example, it is made of polymer such as acryl-based organic resin, polyimide, BCB, PVA, acryl, polyethylene, polycarbonate, polyetherimide and the like, sulfide such as As₂S₃, Sb₂S₃, ZnS and the like, oxide and fluoride. Also, a material that has an insulting property for a charge having one polarity to be accumulated and a conductive property for a charge having the opposite polarity is more preferable. In addition, it is preferable that the difference of a product of mobility and life of charge between an electrode for a given polarity and an electrode for an opposite polarity is three digits or larger.

As the favorable compounds, As₂Se₃, a compound in which Cl, Br and I of 500 ppm to 20,000 ppm are doped in As₂Se₃, As₂(SeₓTe₁₋ₓ)₃ (0.5<x<1) in which Se of As₂Se₃ is replaced with Te by 50%, a compound in which Se of As₂Se₃ is replaced with S by 50%, AsₓSe_{y} (x+y=100, 34≦x≦46) in which As concentration of As₂Se₃ is changed by ±15%, an amorphous Se—Te based compound in which Te is 5 to 30 wt %, and the like may be exemplified.

In the meantime, regarding the charge accumulation layer 343, it is preferable to use a material having a dielectric constant that is 0.5 times to two times of dielectric constants of the photoconductive layer 242 for record and the photoconductive layer 245 for reading so that lines of electric force formed between the first electrode layer 241 and the second electrode layer 246 are not bent.

In this illustrative embodiment, the charge accumulation layer 343 is linearly divided to be parallel in the extending direction of the transparent linear electrodes 246a and light-shielding linear electrodes 246b of the second electrode layer 246, as shown in FIGS. 29A to 29C.

Also, the charge accumulation layer 343 is divided with a pitch smaller than the arrangement pitch of the transparent linear electrodes 246a or light-shielding linear electrodes 246b. However, the arrangement pitch P₂ and distance d₂ thereof are determined so that the phase contrast imaging can be performed by a combination with the grating 131. In the meantime, since the arrangement pitch P₂ and distance d₂ of the transparent linear electrodes 246a or light-shielding linear electrodes 246b are determined to be the same as the arrangement pitch P₂ and distance d₂ of the second grating 132, the same reference numerals are used.

Specifically, when the X-ray irradiated from the X-ray source 11 is a cone beam, rather than a parallel beam, the self-image G1 that is formed as the X-ray has passed through the grating 31 is enlarged in proportion to a distance from the X-ray source 11. In this illustrative embodiment, the arrangement pitch P₂ and the interval d₂ of the charge accumulation layer 343 are determined so that the parts of the linear charge accumulation layer 343 substantially coincide with a period pattern of bright parts of the self-image of the grating 131 at the position of the charge accumulation layer 343. That is, when the grating pitch of the grating 131 is P₁, the interval of the X-ray shield units of the grating 131 is d₁, a distance from the focus of the X-ray source 11 to the grating 131 is L₁ and a distance from the grating 131 to the detection surface of the X-ray image detector 340 is L₂, the arrangement pitch P₂ and the interval d₂ of the charge accumulation layer 343 are determined to satisfy the equations (1) and (2).

Also, the charge accumulation layer 343 is formed to have a thickness of 2 μm or smaller in the stacking direction (Z direction).

Also, the charge accumulation layer 343 may be formed by a resistance heating deposition using the material as described above and a metal mask of a metal plate having perforated holes or a mask made of fiber and the like. Alternatively, the charge accumulation layer may be formed by a photolithography.

In the X-ray image detector 340 of this illustrative embodiment, as specifically described later, one set of the transparent linear electrode 246a and the light-shielding linear electrode 246b, which are adjacent to each other, is used to read out an image signal. That is, as shown in FIG. 29B, an image signal of one pixel is read out by one set of the transparent linear electrode 246a and the light-shielding linear electrode 246b. In this illustrative embodiment, the transparent linear electrode 246a and the light-shielding linear electrode 246b are arranged so that one pixel becomes about 50 μm.

The X-ray phase image capturing apparatus of this illustrative embodiment has, as shown in FIG. 29A, the linear reading light source 250 that extends in the direction (X direction) orthogonal to the extending direction of the transparent linear electrode 246a and the light-shielding linear electrode 246b.

In order to enable the configuration, which includes the X-ray source 11, the grating 131 and the X-ray image detector 340 having the divided charge accumulation layer 343, to function as a Talbot interferometer, some conditions should be further satisfied. The conditions are described in the below.

First, the grating 131 and the detection surface of the X-ray image detector 340 should be parallel with the X-Y plane shown in FIG. 28.

When the grating 131 is a π/2 phase grating, the distance Z₂ (Talbot interference distance Z) between the grating 131 and the detection surface of the X-ray image detector 340 should substantially satisfy the equation (24).

Also, when the grating 131 is a π phase grating, the Talbot interference distance Z should substantially satisfy the equation (25). Further, when the grating 131 is an amplitude modulation type grating, the Talbot interference distance Z should substantially satisfy the equation (3).

The moving mechanism 333 translation-moves the X-ray image detector 340 in the direction orthogonal to the extending direction of the linear electrode thereof, thereby changing the relative position of the grating 131 and the X-ray image detector 340, as described above. The moving mechanism 333 is configured by an actuator such as piezoelectric device, for example.

In the below, the operations of the X-ray phase image capturing apparatus of this illustrative embodiment are described.

The X-ray penetrates the subject H and is then irradiated to the grating 131. The X-ray irradiated to the grating 131 is diffracted in the grating 131, so that a Talbot interference image is formed at a predetermined distance from the grating 131 in the optical axis direction.

Then, the self-image of the grating 131 is incident from the first electrode layer 241 of the X-ray image detector 131, so that it is subject to the intensity modulation by the charge accumulation layer 343 of the X-ray image detector 340. As a result, the self-image is detected, as an image signal of the fringe image reflecting the front only, by the X-ray image detector 340.

Here, the fringe image detection and readout operations of the X-ray image detector 340 are described more specifically.

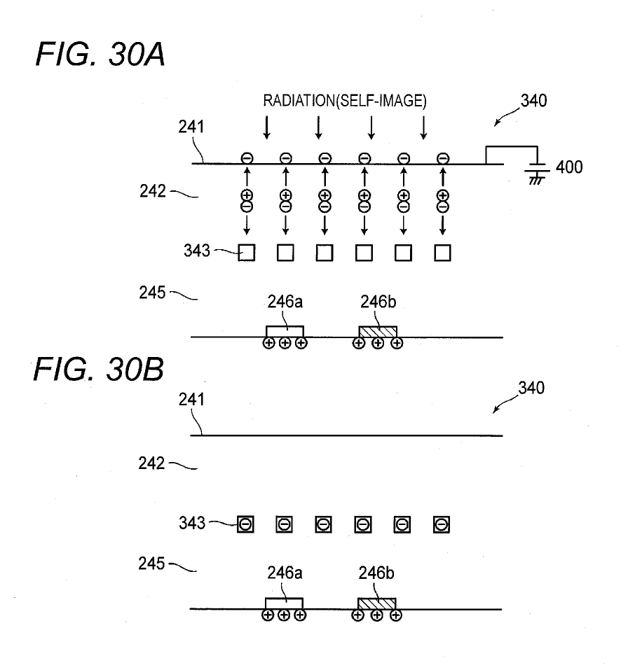

First, as shown in FIG. 30A, at a state in which the negative voltage is applied to the first electrode layer 241 of the X-ray image detector 340 by the high voltage power supply 400, the X-ray carrying the self-image of the grating 131 is irradiated from the first electrode layer 241 of the X-ray image detector 340.

The X-ray irradiated to the X-ray image detector 340 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges are accumulated, as latent image charges, in the electric accumulation layer 343 (refer to FIG. 30B).

In this illustrative embodiment, the charge accumulation layer 343 is linearly divided with the arrangement pitch as described above. Thus, among the charges in the photoconductive layer 242 for record, which are generated in correspondence to the self-image of the grating 131, only the charges below which the charge accumulation layer 343 exists are trapped and accumulated by the charge accumulation layer 343 and the other charges pass through areas of the linear charge accumulation layer 343 (hereinafter, referred to as non-charge accumulation areas), pass through the photoconductive layer 245 for reading and then flow to the transparent linear electrodes 246a and the light-shielding linear electrodes 246b.

Like this, among the charges generated in the photoconductive layer 242 for record, only the charges below which the linear charge accumulation layer 343 exists are accumulated, so that the self-image of the grating 131 is subject to the intensity modulation by the superimposition with the linear pattern of the charge accumulation layer 343. As a result, the image signal of the fringe image reflecting the distortion of the wave front of the self-image by the subject H is accumulated in the charge accumulation layer 343. That is, the charge accumulation layer 343 of this illustrative embodiment has the equivalent function to the second grating of the related phase contrast imaging using two gratings.

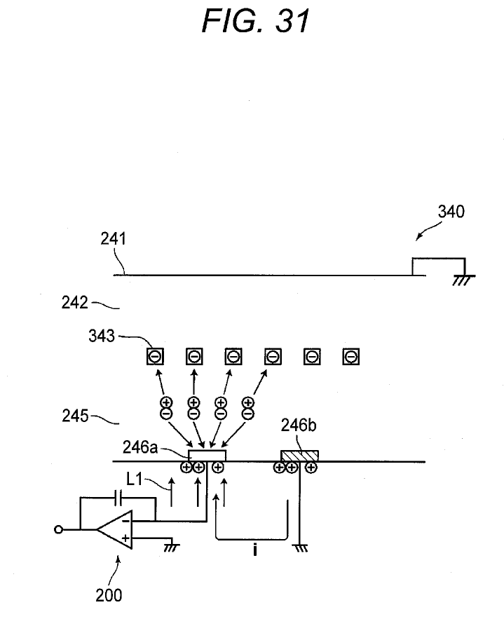

Then, as shown in FIG. 31, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 245 for reading. The positive charges generated in the photoconductive layer 245 for reading by the illumination of the reading light L1 are combined with the latent image charges in the electric accumulation layer 343 and the negative charges are combined with the positive charges that are charged in the light-shielding linear electrode 246b through the charge amplifier 200 connected to the transparent linear electrode 246a.

As the negative charges generated in the photoconductive layer 245 for reading and the positive charges charged in the light-shielding linear electrode 246b are combined, the current flows in the charge amplifier 200 and is integrated and thus detected as an image signal.

The linear reading light source 250 is moved in the sub-scanning direction (Y direction), so that the X-ray image detector 240 is scanned by the linear reading light L1. Thereby, the image signals are sequentially detected for each of the reading lines, which are illuminated by the linear reading light L1, in accordance with the above operations, and the detected image signals for each of the reading lines are sequentially input and stored in the phase contrast image generation unit 260.

The whole surface of the X-ray image detector 340 is scanned by the reading light L1, so that the image signals of a whole one frame are stored in the phase contrast image generation unit 260.

Since the principle of generating the phase contrast image in this illustrative embodiment is the same as the above described with reference to the equations (12) to (18), the description thereof is omitted. The phase contrast image is generated based on the fringe images by the phase contrast image generation unit 260.

In the meantime, the above-described X-ray phase image capturing apparatus satisfies the equation (24), (25) or (3) so that the distance Z₂ from the grating 131 to the X-ray image detector 340 becomes a Talbot interference distance. However, it may be possible to configure the grating 131 so that it projects the incident X-ray without diffracting the same. According to this configuration, since the projection image that is projected through the grating 131 is similarly obtained at all positions of the rear of the grating 131, it is possible to set the distance Z₂ from the grating 131 to the X-ray image detector 340, irrespective of the Talbot interference distance.

In the below, a modified embodiment of the X-ray phase image capturing apparatus is described. According to the above X-ray phase image capturing apparatus, the X-ray image detector 340 is translation-moved by the moving mechanism 333, so that the X-ray image is captured at the respective positions and thus the M fringe image signals are acquired. However, the X-ray phase image capturing apparatus of this embodiment does not require the moving mechanism 333 as described above and is configured to acquire the M fringe image signals by one X-ray image capturing. That is, as described above with reference to FIGS. 17 to 23, also in this embodiment, the grating 131 and the X-ray image detector 340 are arranged so that the extending direction of the grating 131 and the extending direction of the charge accumulation layer 343 of the X-ray image detector 340 are relatively inclined, as shown in FIGS. 17 to 19. Regarding the grating 131 and the charge accumulation layer 343 arranged as such, the main pixel size Dx of the main scanning direction (X direction in FIG. 29) and the sub-pixel size Dy of the sub-scanning direction of each pixel of the image signals detected by the X-ray image detector 340 have a relation as shown in FIG. 18. After one radiological image capturing is performed by the same configurations and operations described with reference to FIGS. 17 to 23, the whole surface of the X-ray image detector 340 is scanned by the reading light L1, so that the image signals of the whole one frame are stored in the phase contrast image generation unit 260. Then, the phase contrast image generation unit 260 acquires the image signals of the five different fringe images, based on the stored image signals. Based on the first to fifth fringe image signals, the phase contrast image generation unit 260 generates a phase contrast image by the same manner as the above-described embodiment.

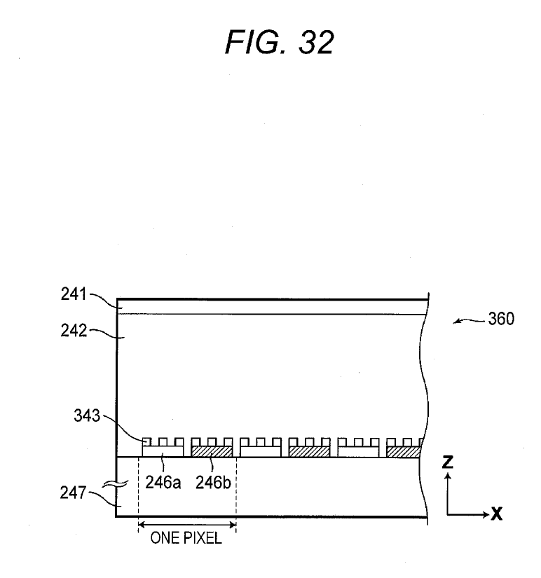

Also, in the above embodiment, the X-ray image detector 340 has the three layers, i.e., the photoconductive layer 242 for record, the charge accumulation layer 343 and the photoconductive layer 245 for reading. However, such layer configuration is not necessarily required. For example, as shown in FIG. 32, a configuration may be possible in which the linear charge accumulation layer 343 is provided to directly contact the transparent linear electrodes 246a and light-shielding linear electrodes 246b without the photoconductive layer 245 for reading and the photoconductive layer 242 for record is provided on the charge accumulation layer 343. Meanwhile, the photoconductive layer 242 for record also functions as the photoconductive layer for reading.

The above structure is a structure in which the charge accumulation layer 343 is directly provided on the second electrode layer 246 without the photoconductive layer 245 for reading, and enables the linear charge accumulation layer 343 to be easily formed. That is, the linear charge accumulation layer 343 can be formed by the vapor deposition. In the vapor deposition, a metal mask and the like is used so as to selectively form a linear pattern. However, in the configuration in which the linear charge accumulation layer 343 is provided on the photoconductive layer 245 for reading, the metal mask is set after the photoconductive layer 245 for reading is vapor-deposited. Accordingly, operations under atmosphere environments are performed between a process of vapor-depositing the photoconductive layer 245 for reading and a process of vapor-depositing the photoconductive layer 242 for record. Thereby, the photoconductive layer 245 for reading may be deteriorated or the foreign substances may be introduced between the photoconductive layers, so that the quality may be deteriorated. However, by omitting the photoconductive layer 245 for reading, it is possible to reduce the operations under atmosphere environments after the vapor deposition of the photoconductive layer, so that it is possible to decrease the concern about the quality deterioration.

In the below, the recording and readout operations of the X-ray image by the X-ray image detector 360 shown in FIG. 32 are described.

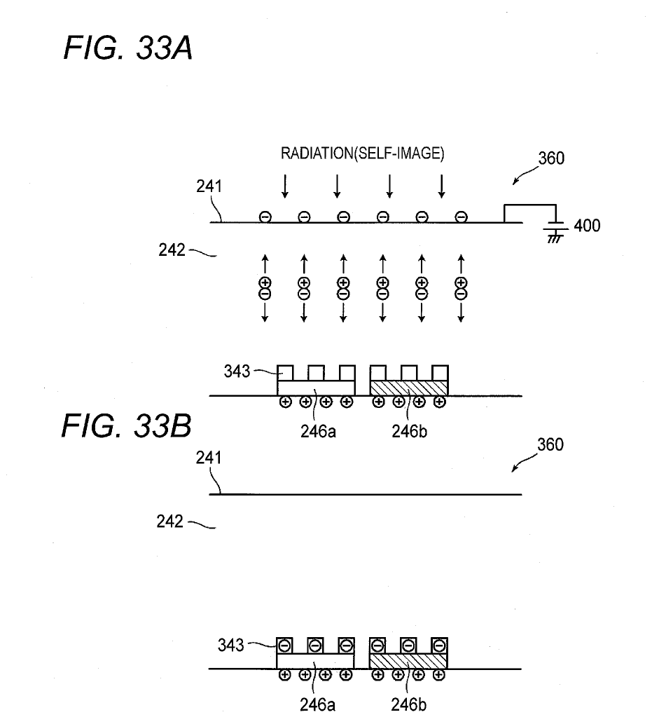

First, as shown in FIG. 33A, at a state in which the negative voltage is applied to the first electrode layer 241 of the X-ray image detector 360 by the high voltage power supply 400, the X-ray carrying the self-image of the grating 131 is irradiated from the first electrode layer 241 of the X-ray image detector 360.

The X-ray irradiated to the X-ray image detector 360 penetrates the first electrode layer 241 and is then irradiated to the photoconductive layer 242 for record. By the irradiation of the X-ray, charge pairs are generated in the photoconductive layer 242 for record, and the positive charges thereof are combined with the negative charges charged in the first electrode layer 241 and thus annihilated and the negative charges are accumulated, as latent image charges, in the charge accumulation layer 343 (refer to FIG. 33B). In the meantime, since the linear charge accumulation layer 343 contacting the second electrode layer 246 is an insulation film, the charges reaching the charge accumulation layer 343 are trapped and thus accumulated therein because the charges cannot reach the second electrode layer 246.

Like the X-ray image detector 340, among the charges generated in the photoconductive layer 242 for record, only the charges below which the charge accumulation layer 343 exists are accumulated, so that the self-image of the grating 131 is subject to the intensity modulation by the superimposition with the linear pattern of the charge accumulation layer 343. As a result, the image signal of the fringe image reflecting the distortion of the wave front of the self-image by the subject H is accumulated in the charge accumulation layer 343.

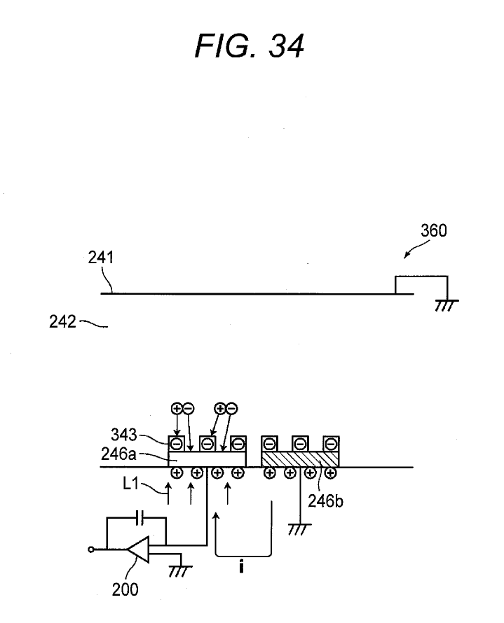

Then, as shown in FIG. 34, at a state in which the first electrode layer 241 is grounded, the linear reading light L1 emitted from the linear reading light source 250 is illuminated from the second electrode layer 246. The reading light L1 penetrates the transparent linear electrode 246a and is then illuminated to the photoconductive layer 242 for record near the charge accumulation layer 343. The positive charges generated by the illumination of the reading light L1 are attracted toward the linear charge accumulation layer 343 and thus recombined. The negative charges are attracted toward the transparent linear electrode 246a and combined with the positive charges charged in the transport linear electrode 246a and the positive charges that are charged in the light-shielding linear electrode 246b through the charge amplifier 200 connected to the transparent linear electrode 246a. Thereby, the current flows in the charge amplifier 200 and is integrated and thus detected as an image signal.

Also in the above configuration in which the X-ray image detector 360 is used, the methods of acquiring the plurality of fringe images and generating the phase contrast image are the same as the above embodiments.

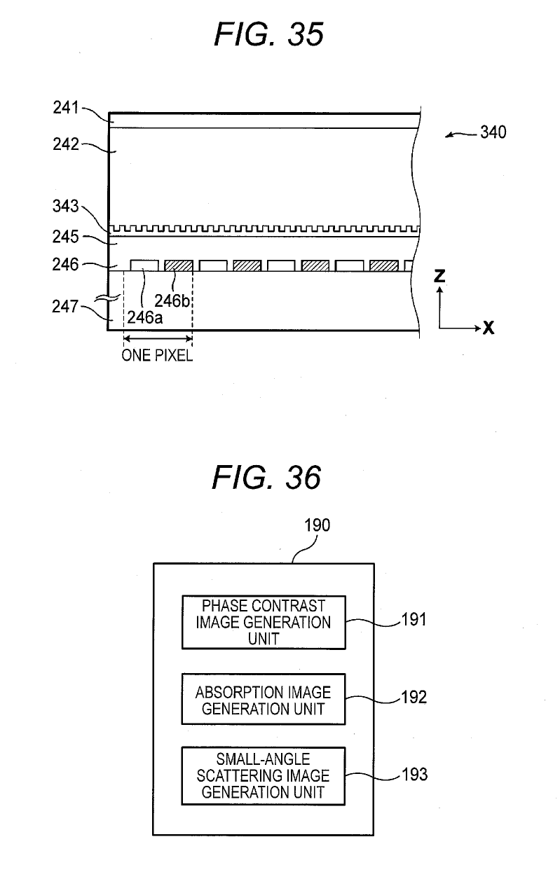

Also, in the respective embodiments, the charge accumulation layer 343 of the X-ray image detector 340 is perfectly linearly divided and separated. However, the invention is not limited thereto. For example, as shown in FIG. 35, the charge accumulation layer may be formed into a grating shape by forming a linear pattern on a flat plate shape.

FIG. 36 shows another example of the radiographic system for illustrating an illustrative embodiment of the invention, which shows a calculation unit thereof.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the subject is increased as the number of the imaging is increased. In addition, in recent years, a small-angle scattering image attracts attention in addition to the phase contrast image and the absorption image. The small-angle scattering image can represent tissue characterization and state caused due to the fine structure in the subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

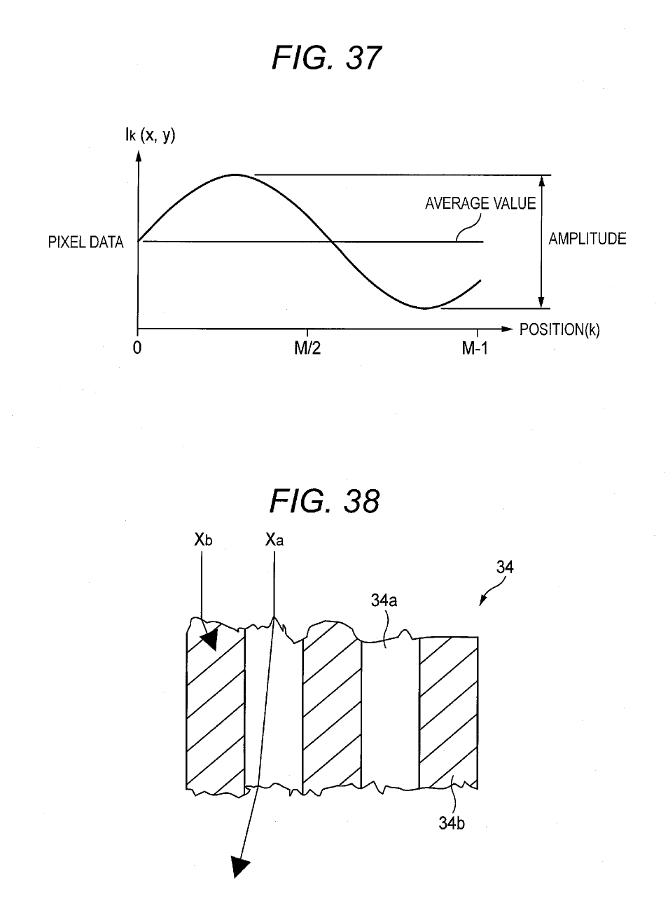

The absorption image generation unit 192 averages the image data Ik(x, y), which is obtained for each pixel, with respect to k, as shown in FIG. 37, and thus calculates an average value and images the image data, thereby generating an absorption image. Also, the calculation of the average value may be performed simply by averaging the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

In the meantime, it may be possible to prepare an absorption image from an image group that is acquired by performing the imaging (pre-imaging) at a state in which there is no subject. The absorption image reflects a transmittance non-uniformity of a detection system (that is, the absorption image includes information such as a transmittance non-uniformity of grids, an absorption influence of a radiation dose detector, and the like). Therefore, from the image, it is possible to prepare a correction coefficient map for correcting the transmittance non-uniformity of the detection system. Also, by preparing an absorption image from an image group that is acquired by performing the imaging (main imaging) at a state in which there is a subject and multiplying the respective pixels with the correction coefficient, it is possible to acquire an absorption image of the subject in which the transmittance non-uniformity of the detection system is corrected.

The small-angle scattering image generation unit 193 calculates an amplitude value of the image data Ik(x, y), which is obtained for each pixel, and thus images the image data, thereby generating a small-angle scattering image. Meanwhile, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

In the meantime, it may be possible to prepare a small-angle scattering image from the image group that is acquired by performing the imaging (pre-imaging) at a state in which there is no subject. The small-angle scattering image reflects amplitude value non-uniformity of a detection system (that is, the small-angle scattering image includes information such as pitch non-uniformity of grids, opening ratio non-uniformity, non-uniformity due to the relative position difference between the grids, and the like). Therefore, from the image, it is possible to prepare a correction coefficient map for correcting the amplitude value non-uniformity of the detection system. Also, by preparing a small-angle scattering image from an image group that is acquired by performing the imaging (main imaging) at a state in which there is a subject and multiplying the respective pixels with the correction coefficient, it is possible to acquire a small-angle scattering image of the subject in which the amplitude value non-uniformity of the detection system is corrected.

According to the X-ray imaging system of this illustrative embodiment, the absorption image or small-angle scattering image is generated from the plurality of images acquired for the phase contrast image of the subject. Accordingly, the capturing positions between the capturing of the phase contrast image and the capturing of the absorption image are not deviated, so that it is possible to favorably superimpose the phase contrast image and the absorption image or small-angle scattering image.

In the respective X-ray imaging systems, it has been described that the general X-ray is used as the radiation. However, the radiation that is used for the invention is not limited to the X-ray. For example, the radiations except for the X-ray, such as α-ray and γ-ray, may be also used.

The above illustrative embodiments relate to the application in which the invention is applied to the medical diagnosis apparatus. However, the invention is not limited to the medical diagnosis apparatus and can be applied to the other radiation detection apparatus for industrial use.

As describe above, the specification discloses a radiological image detection apparatus including:

a first grating;

a grating pattern having a period that substantially coincides with a pattern period of a radiological image formed by radiation having passed through the first grating;

a radiological image detector that detects the radiological image masked by the grating pattern, and

an anti-scatter grating that is arranged on a path of the radiation incident onto the radiological image detector and removes scattered radiation,

wherein a smoothing process is performed for at least one of a surface and a backside of the anti-scatter grating intersecting with a traveling direction of the radiation.

Also, according to the radiological image detection apparatus disclosed in the specification, the anti-scatter grating is formed by slicing a base material, in which a radiation absorption member, which absorbs a predetermined amount of the radiation, and a radiation penetration member having an absorption amount of the radiation smaller than that of the radiation absorption member are stacked, along a plane intersecting with the stacking direction.

Also, according to the radiological image detection apparatus disclosed in the specification, the smoothing process is a film formation process.

Also, according to the radiological image detection apparatus disclosed in the specification, the anti-scatter grating includes a radiation absorption member that absorbs a predetermined amount of the radiation and a radiation penetration member having an absorption amount of the radiation smaller than that of the radiation absorption member, and a difference between a refractive index of a material of a film formed by the film formation process and a refractive index of the radiation penetration member is smaller than a difference between refractive indices of water and air.

Also, according to the radiological image detection apparatus disclosed in the specification, a thickness of the film formed by the film formation process is 10 nm or larger and 1 nm or smaller.

Also, according to the radiological image detection apparatus disclosed in the specification, the smoothing process is a grind process.

Also, according to the radiological image detection apparatus disclosed in the specification, a surface roughness RMS of the surface of the anti-scatter grating for which the smoothing process has been performed is 10 nm or smaller.

Also, according to the radiological image detection apparatus disclosed in the specification, the grating pattern is a second grating.

Also, according to the radiological image detection apparatus disclosed in the specification, the anti-scatter grating is arranged between the first grating and the second grating.

Also, the specification discloses a radiographic apparatus including:

the radiological image detection apparatus, and

a radiation source that irradiates the radiation toward the first grating.

Also, the specification discloses a radiographic system including:

the radiological image detection apparatus, and

a calculation processing unit that calculates, from an image detected by the radiological image detector of the radiographic apparatus, a refraction angle distribution of the radiation incident onto the radiological image detector and generates a phase contrast image of a subject based on the refraction angle distribution.

What is claimed is:

1. A radiological image detection apparatus comprising:
a first grating unit;
a grating pattern unit that has a period that substantially coincides with a pattern period of a radiological image formed by radiation having passed through the first grating unit;
a radiological image detector that detects the radiological image masked by the grating pattern unit, and
an anti-scatter grating that is arranged on a path of the radiation incident onto the radiological image detector and removes scattered radiation,
wherein a smoothing process is performed for at least one of a surface and a backside of the anti-scatter grating intersecting with a traveling direction of the radiation.

2. The radiological image detection apparatus according to claim 1, wherein the anti-scatter grating is formed by slicing a base material, in which a radiation absorption member, which absorbs a predetermined amount of the radiation, and a radiation penetration member having an absorption amount of the radiation smaller than that of the radiation absorption member are stacked, along a plane intersecting with the stacking direction.

3. The radiological image detection apparatus according to claim 1, wherein the smoothing process is a film formation process.

4. The radiological image detection apparatus according to claim 3, wherein the anti-scatter grating includes a radiation absorption member that absorbs a predetermined amount of the radiation and a radiation penetration member having an absorption amount of the radiation smaller than that of the radiation absorption member, and
wherein a difference between a refractive index of a material of a film formed by the film formation process and a refractive index of the radiation penetration member is smaller than a difference between refractive indices of water and air.

5. The radiological image detection apparatus according to claim 3, wherein a thickness of the film formed by the film formation process is 100 nm or larger and 1 mm or smaller.

6. The radiological image detection apparatus according to claim 1, wherein the smoothing process is a grind process.

7. The radiological image detection apparatus according to claim 1, wherein a surface roughness RMS of the surface of the anti-scatter grating for which the smoothing process has been performed is 10 nm or smaller.

8. The radiological image detection apparatus according to claim 1, wherein the grating pattern unit is a second grating unit.

9. The radiological image detection apparatus according to claim 8, wherein the anti-scatter grating is arranged between the first grating unit and the second grating unit.

10. A radiographic apparatus comprising:
the radiological image detection apparatus according to claim 1, and
a radiation source that irradiates the radiation toward the first grating unit.

11. A radiographic system comprising:
the radiological image detection apparatus according to claim 10, and
a calculation processing unit that calculates, from an image detected by the radiological image detector of the radiographic apparatus, a refraction angle distribution of the radiation incident onto the radiological image detector and generates a phase contrast image of a subject based on the refraction angle distribution.
